(19) United States
(12) Patent Application Publication
(10) Pub. No.: US 2023/0109911 A1
(43) Pub. Date: Apr. 13, 2023

(54) IMAGE PROCESSING APPARATUS, IMAGE PROCESSING METHOD, AND PROGRAM

(71) Applicant: SONY GROUP CORPORATION, TOKYO (JP)

(72) Inventors: HIROSHI YAMAMOTO, TOKYO (JP); TAKAYOSHI OZONE, TOKYO (JP); RYUICHI TADANO, TOKYO (JP)

(21) Appl. No.: 17/905,473

(22) PCT Filed: Feb. 4, 2021
(86) PCT No.: PCT/JP2021/004161

§ 371 Date: Sep. 1, 2022

(30) Foreign Application Priority Data
Mar. 9, 2020 (JP) 2020-039702

(51) Int. Cl. H04N 23/68; H04N 23/62

(52) U.S. Cl. CPC H04N 23/683; H04N 23/62

(57) ABSTRACT

An image processing apparatus performs parameter setting processing of setting a parameter of processing of another element according to one element of a first element that is one element among a plurality of elements related to a shake of input movie data and a second element that is an element related to the input movie data and other than the first element, and processing related to the another element by using a parameter set by the parameter setting processing.

### TECHNICAL FIELD

The present technology relates to an image processing apparatus, an image processing method, and a program, and particularly relates to image processing using an image shake.

### BACKGROUND ART

A technology for performing image processing such as various corrections on a movie captured by an image-capturing apparatus is known.

Patent Document 1 below discloses performing vibration-proof processing to movie data related to a photographed image, and eliminating the influence of the vibration-proof processing to the movie data after the vibration-proof processing.

### CITATION LIST

### Patent Document

Patent Document 1: Japanese Patent Application Laid-Open No. 2015-216510

### SUMMARY OF THE INVENTION

### Problems to be Solved by the Invention

By the way, in recent years, a user can easily perform image capturing, image adjustment, and the like using a mobile terminal such as a smartphone or a tablet, a camera itself, a personal computer, or the like, and movie posting is also active.

Under such an environment, it is desired not to output an image captured by the user as it is but to produce an image with higher quality or various images.

Furthermore, it is also desired that a broadcaster and the like can perform various production of images.

Therefore, focusing on a shake component in a movie, the present disclosure proposes a technology capable of widening expression and production of images and audio.

### Solutions to Problems

An image processing apparatus according to the present technology includes: a parameter setting unit configured to set a parameter of processing of another element according to one element of a first element that is one element among a plurality of elements related to a shake of input movie data and a second element that is an element related to the input movie data and other than the first element; and a processing unit configured to perform processing related to the another element by using a parameter set by the parameter setting unit.

Examples of the element of shake include a roll component, a yaw component, a pitch component, and a dolly component of shake. For example, in a case where a roll component of shake is one element, other elements include a shake element such as a pitch component, luminance of an image, a color of an image, and a volume, audio quality, frequency, pitch, and the like of audio accompanying an image.

In the image processing apparatus according to the present technology described above, it is conceivable that the parameter setting unit sets a parameter for changing the second element according to the first element.

Other shake components, audio, and luminance and color of an image are changed according to a shake component that is a first element, for example.

In the image processing apparatus according to the present technology described above, it is conceivable that the parameter setting unit sets a parameter for changing the first element according to the second element.

For example, a shake component that is the first element is changed according to a shake component other than the first element, audio, or luminance or color of an image.

In the image processing apparatus according to the present technology described above, it is conceivable to include, as the processing unit, a shake change unit configured to perform processing of changing a state of shake of a movie using a parameter set by the parameter setting unit.

That is, the shake change unit changes the state of a shake that is the second element according to a shake as the first element.

In the image processing apparatus according to the present technology described above, it is conceivable to include, as the processing unit, an audio processing unit configured to perform audio signal processing using a parameter set by the parameter setting unit.

That is, the audio processing unit performs audio signal processing so as to change an element related to audio as the second element according to the shake as the first element.

In the image processing apparatus according to the present technology described above, it is conceivable to include, as the processing unit, an image processing unit configured to perform image signal processing using a parameter set by the parameter setting unit.

That is, the image processing unit performs image signal processing so as to change the element of the image that is the second element according to the shake as the first element.

In the image processing apparatus according to the present technology described above, it is conceivable to further include a user interface processing unit configured to present an operator for selecting the first element and the second element.

That is, the user can select which element to change according to which element related to the input movie data.

In the image processing apparatus according to the present technology described above, it is conceivable that the operator presents directivity from the one element to the other element for the first element and the second element.

For example, a direction reflecting by an arrow between the first element and the second element is presented.

In the image processing apparatus according to the present technology described above, it is conceivable that the operator can designate one or both of the first element and the second element a plurality of times.

For example, a plurality of one or both of the first element and the second element can be selected.

In the image processing apparatus according to the present technology described above, it is conceivable that an element of a shake of the input movie data includes at least any of a shake in a yaw direction, a shake in a pitch direction, a shake in a roll direction, and a shake in a dolly direction.

In an image processing method according to the present technology, an image processing apparatus performs: parameter setting processing of setting a parameter of processing of another element according to one element of a first element that is one element among a plurality of elements related to a shake of input movie data and a second element that is an element related to the input movie data and other than the first element; and processing related to the another element by using a parameter set by the parameter setting processing. Thus, processing as production of shake, image, or audio with respect to an image is performed.

A program according to the present technology is a program that causes an information processing apparatus to execute processing corresponding to such an image processing method. This enables image processing of the present disclosure to be executed by various information processing apparatuses.

### BRIEF DESCRIPTION OF DRAWINGS

FIG. 1 is an explanatory diagram of equipment used in an embodiment of the present technology.

FIG. 2 is an explanatory diagram of information transmitted between pieces of equipment of the embodiment.

FIG. 3 is a block diagram of an image-capturing apparatus of the embodiment.

FIG. 4 is an explanatory diagram of shake removal processing of an image in the image-capturing apparatus of the embodiment.

FIG. 5 is a block diagram of an information processing apparatus of the embodiment.

FIG. 6 is an explanatory diagram of a functional configuration as an image processing apparatus of the embodiment.

FIG. 7 is an explanatory diagram of another functional configuration as an image processing apparatus of the embodiment.

FIG. 8 is an explanatory diagram of an image example of an operator of the embodiment.

FIG. 9 is an explanatory diagram of an audio processing example according to a shake of the embodiment.

FIG. 10 is an explanatory diagram of an audio processing example according to a shake of the embodiment.

FIG. 11 is an explanatory diagram of an audio processing example according to a shake of the embodiment.

FIG. 12 is an explanatory diagram of content of a movie file and metadata of the embodiment.

FIG. 13 is an explanatory diagram of metadata regarding lens distortion correction.

FIG. 14 is an explanatory diagram of image processing of the embodiment.

FIG. 15 is an explanatory diagram of pasting to a celestial sphere model of the embodiment.

FIG. 16 is an explanatory diagram of sample timing of IMU data of the embodiment.

FIG. 17 is an explanatory diagram of shake information adjustment for each frequency band of the embodiment.

FIG. 18 is an explanatory diagram of shake information adjustment for each direction of the embodiment.

FIG. 19 is an explanatory diagram of shake information adjustment for each frequency band and for each direction of the embodiment.

FIG. 20 is an explanatory diagram of association between an output image and a celestial sphere model of the embodiment.

FIG. 21 is an explanatory diagram of rotation of an output coordinate plane and perspective projection of the embodiment.

FIG. 22 is an explanatory diagram of a clipping region of the embodiment.

### MODE FOR CARRYING OUT THE INVENTION

An embodiment will be described below in the following order.

<1. Configuration of equipment applicable as image processing apparatus>

<2. Apparatus configuration and processing function>

<3. Movie file and metadata>

<4. Image processing of embodiment>

<5. Summary and modifications>

Prior to description of the embodiment, some terms used in the description will be described.

“Shake” refers to an interframe shake of an image constituting a movie. It is assumed to widely refer to vibration components (interframe shake of image) occurring between frames, such as a shake caused by camera shake or the like in an image captured by a so-called image-capturing apparatus, a shake intentionally added by image processing, and the like.

“Shake change (interframe shake modification)” refers to changing a state of a shake in an image, such as reduction of a shake occurring in the image or addition of a shake to the image.

It is assumed that this “shake change” includes the following “shake removal (interframe shake reduction)” and “shake production (interframe shake production)”.

“Shake removal” refers to elimination (shake total removal) or reduction (shale partial removal) of a shake occurring in an image due to camera shake or the like. For example, it refers to adjusting to reduce a shake on the basis of shake information at the time of image capturing. So-called image stabilization performed in the image-capturing apparatus is to perform shake removal.

There is a case where “shake production” is to add a shake to an image or reduce a shake, and in this sense, it sometimes becomes similar to “shake removal” as a result. However, in the present embodiment, a change amount of shake is instructed by a user's operation or automatic control, and the shake state of the image is changed according to the instruction. For example, “shake production” corresponds to reducing or increasing shake by changing shake information at the time of image capturing by a user instruction or the like and performing shake change processing on the basis of the changed shake information, or reducing or increasing shake by changing shake on the basis of information added with the shake generated by a user instruction or the like.

Even in a case of adjusting the shake toward suppressing the shake, for example, it can be considered that intentionally adjusting the shake corresponds to “shake production”.

Note that, as an example of the purpose of shake production, it is assumed to intentionally shake an image in order to give punch to the scene of a movie.

“Image-capturing time shake information” is information regarding a shake at the time of capturing by the image-capturing apparatus, and corresponds to detection information of motion of the image-capturing apparatus, information that can be calculated from the detection information, posture information indicating the posture of the image-capturing apparatus, shift and rotation information as motion of the image-capturing apparatus, and the like.

In the embodiment, specific examples of “image-capturing time shake information” include quaternion (QD) and IMU data, but there are also shift and rotation information, and there is no particular limitation.

“Adjusted shake information” is shake information generated by adjusting the image-capturing time shake information, and is information used for shake change processing. For example, it is shake information adjusted according to a user operation or automatic control.

In the embodiment, specific examples of “adjusted shake information” include an adjusted quaternion (eQD), but they may be, for example, adjusted IMU data or the like.

<1. Configuration of Equipment Applicable as Image Processing Apparatus>

In the embodiment below, an example in which the image processing apparatus according to the present disclosure is mainly achieved by an information processing apparatus such as a smartphone or a personal computer will be described, but the image processing apparatus can be achieved in various equipment. First, equipment to which the technology of the present disclosure can be applied will be described.

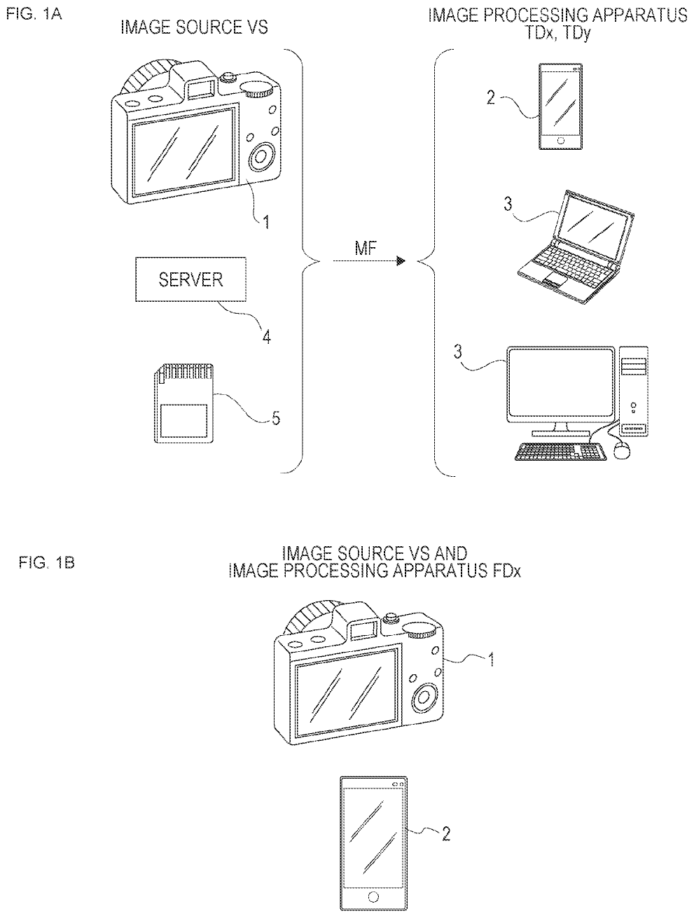

FIG. 1A illustrates an example of an image source VS and an image processing apparatus (TDx, TDy) that acquires a movie file MF from the image source VS. The movie file MF includes image data (that is, movie data) and audio data constituting the movie. However, there may be an audio file separately from the movie file so that synchronization can be performed. The movie data also includes a plurality of continuous still image data.

Note that the image processing apparatus TDx is assumed to be equipment that primarily performs shake change processing on movie data acquired from the image source VS.

On the other hand, the image processing apparatus TDy is assumed to be equipment that secondarily performs shake change processing on movie data already subjected to shake change processing by another image processing apparatus.

As the image source VS, an image-capturing apparatus 1, a server 4, a recording medium 5, and the like are assumed.

As the image processing apparatuses TDx and TDy, a mobile terminal 2 such as a smartphone, a personal computer 3, or the like is assumed. Although not illustrated, various other equipment such as an image editing dedicated apparatus, a cloud server, a television apparatus, and a video recording and reproducing apparatus, are assumed as the image processing apparatuses TDx and TDy. These equipment can function as any of the image processing apparatuses TDx and TDy.

The image-capturing apparatus 1 as the image source VS is a digital camera or the like capable of capturing a movie, and transfers the movie file MF obtained by capturing a movie to the mobile terminal 2, the personal computer 3, or the like via wired communication or wireless communication.

The server 4 may be any of a local server, a network server, a cloud server, and the like, but refers to an apparatus that can provide the movie file MF captured by the image-capturing apparatus 1. It is conceivable that the server 4 transfers the movie file MF to the mobile terminal 2, the personal computer 3, or the like via some transmission path.

The recording medium 5 may be any of a solid-state memory such as a memory card, a disk-like recording medium such as an optical disk, a tape-like recording medium such as a magnetic tape, and the like, but refers to a removable recording medium on which the movie file MF captured by the image-capturing apparatus 1 is recorded. It is conceivable that the movie file MF read from the recording medium 5 is read by the mobile terminal 2, the personal computer 3, or the like.

The mobile terminal 2, the personal computer 3, and the like as the image processing apparatuses TDx and TDy can perform image processing on the movie file MF acquired from the image source VS described above. The image processing mentioned here includes shake change processing (shake production and shake removal).

Shake change processing is performed, for example, by performing pasting processing to a celestial sphere model for each frame of the movie data, and then rotating by using posture information corresponding to the frame.

Note that a certain mobile terminal 2 or personal computer 3 sometimes serves as the image source VS for another mobile terminal 2 or personal computer 3 functioning as the image processing apparatuses TDx and TDy.

FIG. 1B illustrates the image-capturing apparatus 1 and the mobile terminal 2 as one piece of equipment that can function as both the image source VS and the image processing apparatus TDx.

For example, a microcomputer or the like inside the image-capturing apparatus 1 performs shake change processing.

That is, the image-capturing apparatus 1 is assumed to be able to perform image output as an image processing result applied with shake removal or shake production by performing shake change processing on the movie file MF generated by image capturing.

The mobile terminal 2 can similarly be the image source VS by including an image-capturing function, and therefore it is possible to perform image output as an image processing result applied with shake removal or shake production by performing the shake change processing on the movie file MF generated by image capturing.

Of course, not limited to the image-capturing apparatus 1 and the mobile terminal 2, there are various other equipment that can serve as an image source and an image processing apparatus.

As described above, there are various apparatuses that function as the image processing apparatuses TDx and TDy of the embodiment and the image sources VS, but in the following description, the image source VS such as the image-capturing apparatus 1, the image processing apparatus TDx such as the mobile terminal 2, and the other image processing apparatuses TDy will be described as separate pieces of equipment.

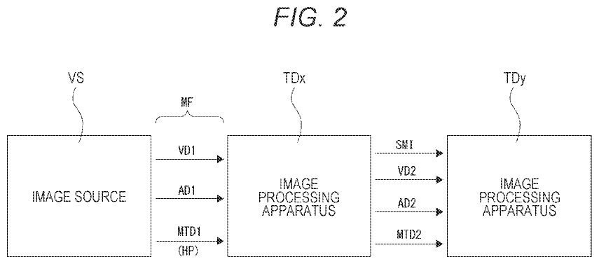

FIG. 2 illustrates a state of information transmission in the image source VS, the image processing apparatus TDx, and the image processing apparatus TDy.

Movie data VD1, audio data AD1, and metadata MTD1 are transmitted from the image source VS to the image processing apparatus TDx via wired communication, wireless communication, or a recording medium.

As will be described later, the movie data VD1, the audio data AD1, and the metadata MTD1 are information transmitted as the movie file MF, for example.

The metadata MTD1 may include a coordinate transformation parameter HP as information of shake removal at the time of image capturing performed as image stabilization or the like, for example.

The image processing apparatus TDx can perform various types of processing in response to the movie data VD1, the audio data AD1, the metadata MTD1, and the coordinate transformation parameter HP.

For example, the image processing apparatus TDx can perform shake change processing on the movie data VD1 using image-capturing time shake information included in the metadata MTD1.

Furthermore, for example, the image processing apparatus TDx can also cancel the shake removal applied to the movie data VD1 at the time of image capturing by using the coordinate transformation parameter HP included in the metadata MTD1.

Furthermore, for example, the image processing apparatus TDx can perform various types of processing (audio processing and image processing) on the audio data AD1 and the movie data VD1.

In a case of performing shake change processing, image processing, or audio processing, the image processing apparatus TDx may perform processing of associating movie data, image-capturing time shake information, and the shake change information SMI with which the processing amount of the shake change processing can be specified.

Then, the associated movie data, the image-capturing time shake information, and the shake change information SMI can be transmitted to the image processing apparatus TDy collectively or separately via wired communication, wireless communication, or a recording medium.

Here, the term “associate” means that, for example, when one piece of information (data, command, program, and the like) is processed, the other piece of information can be used (linked). That is, pieces of information associated with each other may be put together as one file or the like, or may be individual pieces of information. For example, information B associated with information A may be transmitted on a transmission path different from the transmission path for the information A. Furthermore, for example, the information B associated with the information A may be recorded in a recording medium different from the recording medium (or another recording area of the same recording medium) for the information A. Note that this “association” may be a part of information instead of the entire information. For example, an image and information corresponding to the image may be associated with each other in a discretionary unit such as a plurality of frames, one frame, or a part in a frame.

More specifically, “associate” includes actions such as giving a same ID (identification information) to a plurality of pieces of information, recording a plurality of pieces of information into a same recording medium, storing a plurality of pieces of information into a same folder, storing a plurality of pieces of information into a same file (giving one to the other as metadata), embedding a plurality of pieces of information into a same stream, and embedding meta into an image such as a digital watermark.

FIG. 2 illustrates movie data transmitted from the image processing apparatus TDx to the image processing apparatus TDy as movie data VD2. Various examples of the movie data VD2 include an image in which shake removal performed by the image-capturing apparatus 1 is canceled, an image in which shake change is performed by the image processing apparatus TDx, an image before shake change processing is performed by the image processing apparatus TDx, and an image in which image processing other than shake change is performed.

Furthermore, FIG. 2 illustrates audio data AD2 transmitted from the image processing apparatus TDx to the image processing apparatus TDy. It is conceivable that the audio data AD2 is audio data subjected to audio processing by the image processing apparatus TDx.

Furthermore, FIG. 2 illustrates metadata MTD2 transmitted from the image processing apparatus TDx to the image processing apparatus TDy. The metadata MTD2 is the information same as or information partially different from the metadata MTD1. However, the metadata MTD2 includes image-capturing time shake information.

Therefore, the image processing apparatus TDy can acquire, at least the movie data VD2, image-capturing time shake information included in the metadata MTD2, and the shake change information SMI in an associated state.

Note that it is also conceivable a data form in which the shake change information SMI is also included in the metadata MTD2.

Hereinafter, the present embodiment will be described focusing on image processing executed by the image processing apparatus TDx.

<2. Apparatus Configuration and Processing Function>

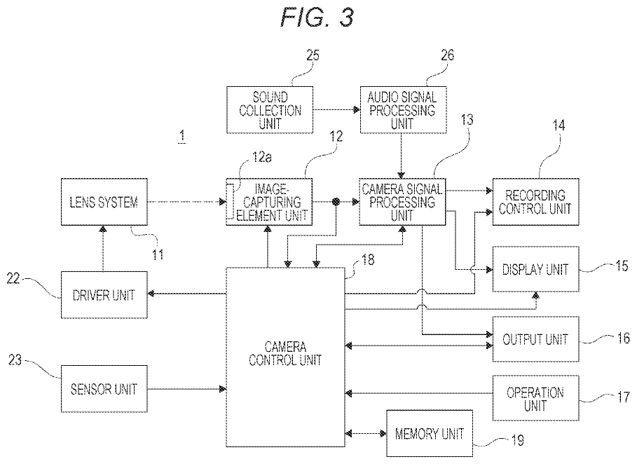

First, a configuration example of the image-capturing apparatus 1 serving as the image source VS will be described with reference to FIG. 3.

Note that, in a case where it is assumed that the movie file MF captured by the mobile terminal 2 is subjected to image processing by the mobile terminal 2 as described with reference to FIG. 1B, the mobile terminal 2 only needs to include a configuration equivalent to the image-capturing apparatus 1 below regarding the image-capturing function.

Furthermore, the image-capturing apparatus 1 performs processing of reducing shake in an image due to motion of the image-capturing apparatus at the time of image capturing, which is so-called image stabilization, and this is “shake removal” performed by the image-capturing apparatus. On the other hand, “shake production” and “shake removal” performed by the image processing apparatus TDx are separate processing independent of “shake removal” performed at the time of image capturing by the image-capturing apparatus 1.

As illustrated in FIG. 3, the image-capturing apparatus 1 includes, for example, a lens system 11, an image-capturing element unit 12, a camera signal processing unit 13, a recording control unit 14, a display unit 15, an output unit 16, an operation unit 17, a camera control unit 18, a memory unit 19, a driver unit 22, and a sensor unit 23.

The lens system 11 includes lenses such as a cover lens, a zoom lens, and a focus lens, and a diaphragm mechanism. Light (incident light) from a subject is guided by this lens system 11 and collected on the image-capturing element unit 12.

Note that, although not illustrated, there is a case where the lens system 11 is provided with an optical image stabilization mechanism that corrects interframe shake and blur of an image due to camera shake or the like.

The image-capturing element unit 12 includes, for example, an image sensor 12a (image-capturing element) of a complementary metal oxide semiconductor (CMOS) type, a charge coupled device (CCD) type, or the like.

This image-capturing element unit 12 executes, for example, correlated double sampling (CDS) processing, automatic gain control (AGC) processing, and the like for an electrical signal obtained by photoelectrically converting light received by the image sensor 12a, and further performs analog/digital (A/D) conversion processing. Then, an image-capturing signal as digital data is output to the camera signal processing unit 13 and the camera control unit 18 in the subsequent stage.

Note that, as an optical image stabilization mechanism not illustrated, there are a case of a mechanism that corrects a shake in an image by moving not the lens system 11 side but the image sensor 12a side, a case of a balanced optical image stabilization mechanism using a gimbal, and the like, and any method may be used.

In the optical image stabilization mechanism, blur in a frame is also corrected as described later in addition to a shake.

The camera signal processing unit 13 is configured as an image processing processor by, for example, a digital signal processor (DSP) or the like. This camera signal processing unit 13 performs various types of signal processing on a digital signal (captured image signal) from the image-capturing element unit 12. For example, as a camera process, the camera signal processing unit 13 performs preprocessing, synchronization processing, YC generation processing, resolution conversion processing, codec processing, and the like.

Furthermore, the camera signal processing unit 13 also performs various types of correction processing. However, there are cases where image stabilization is performed in the image-capturing apparatus 1 or not performed.

The preprocessing includes clamp processing of clamping the black levels of R, G, and B to a predetermined level, correction processing among the color channels of R, G, and B, and the like for a captured image signal from the image-capturing element unit 12.

The synchronization processing includes color separation processing for image data for each pixel to have all the R, G, and B color components. For example, in a case of an image-capturing element using a Bayer array color filter, demosaic processing is performed as color separation processing.

In the YC generation processing, a luminance (Y) signal and a color (C) signal are generated (separated) from the R, G, and B image data.

In the resolution conversion processing, the resolution conversion processing is executed on image data subjected to various types of signal processing.

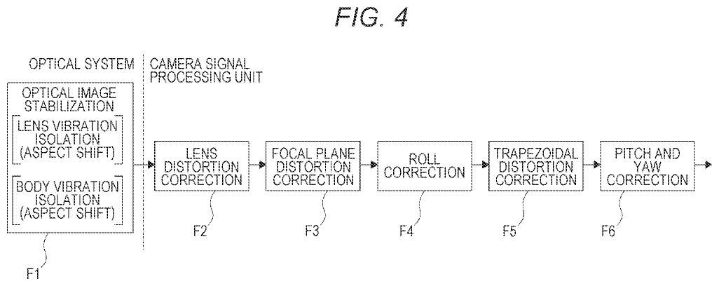

FIG. 4 presents an example of various types of correction processing (internal correction of the image-capturing apparatus 1) performed by the camera signal processing unit 13. FIG. 4 exemplifies the correction processing performed by the camera signal processing unit 13 together with the optical image stabilization performed by the lens system 11 in the execution order.

In the optical image stabilization as processing F1, in-lens image stabilization by shift in the yaw direction and the pitch direction of the lens system 11 and in-body image stabilization by shift in the yaw direction and the pitch direction of the image sensor 12a are performed, so that an image of the subject is formed on the image sensor 12a in a state where the influence of camera shake is physically canceled.

There is a case where only one of the in-lens image stabilization and the in-body image stabilization is used, and there is a case where both of them are used. In the case where both the in-lens image stabilization and the in-body image stabilization are used, it is conceivable that shift in the yaw direction and the pitch direction is not performed in the in-body image stabilization.

Furthermore, there is a case where neither the in-lens image stabilization nor the in-body image stabilization is adopted, and only electrical image stabilization or only optical image stabilization is performed for camera shake.

In the camera signal processing unit 13, the processing from processing F2 to processing F7 is performed by spatial coordinate transformation for each pixel.

In the processing F2, lens distortion correction is performed.

In the processing F3, focal plane distortion correction as one element of the electrical image stabilization is performed. Note that this is to correct distortion in a case where reading by the rolling shutter method is performed by the CMOS image sensor 12a, for example.

In the processing F4, roll correction is performed. That is, correction of the roll component as one element of the electrical image stabilization is performed.

In the processing F5, trapezoidal distortion correction is performed for the trapezoidal distortion amount caused by electrical image stabilization. The trapezoidal distortion amount caused by the electrical image stabilization is perspective distortion caused by clipping a place away from the center of the image.

In the processing F6, shift and clipping in the pitch direction and the yaw direction are performed as one element of the electrical image stabilization.

For example, the image stabilization, the lens distortion correction, and the trapezoidal distortion correction are performed by the above procedure.

Note that it is not essential to perform all the processing described here, and the order of the processing may be appropriately switched.

In codec processing in the camera signal processing unit 13 of FIG. 3, for example, encoding processing for recording or communication and file generation are performed on the image data subjected to the above-described various types of processing. For example, the movie file MF is generated as an MP4 format or the like used for recording movies and audio conforming to MPEG-4. Furthermore, it is also conceivable to generate a file in a format such as Joint Photographic Experts Group (JPEG), Tagged Image File Format (TIFF), Graphics Interchange Format (GIF), or High Efficient Image File (HEIF) as a still image file.

Note that the camera signal processing unit 13 also generates metadata to be added to the movie file MF by using information or the like from the camera control unit 18.

Furthermore, FIG. 3 illustrates a sound collection unit 25 and an audio signal processing unit 26 as an audio processing system.

The sound collection unit 25 includes one or a plurality of microphones, microphone amplifiers, and the like, and collects monaural or stereo audio.

The audio signal processing unit 26 performs digital signal processing such as A/D conversion processing, filter processing, tone processing, and noise reduction on the audio signal obtained by the sound collection unit 25, and outputs audio data to be recorded/transferred together with image data.

The audio data output from the audio signal processing unit 26 is processed together with an image in the camera signal processing unit 13 and included in the movie file MF.

The recording control unit 14 performs recording and reproduction on a recording medium by a nonvolatile memory, for example. For example, the recording control unit 14 performs processing of recording the movie file MF, a thumbnail image, and the like of movie data, still image data, and the like on a recording medium.

Actual forms of the recording control unit 14 can be conceived in various ways. For example, the recording control unit 14 may be configured as a flash memory built in the image-capturing apparatus 1 and its write/read circuit, or may be in a form of a card recording and reproduction unit configured to perform recording and reproduction access to a recording medium that can be pasted to and detached from the image-capturing apparatus 1, for example, a memory card (portable flash memory or the like). Furthermore, as a form built in the image-capturing apparatus 1, there is a case where the recording control unit 14 is achieved as a hard disk drive (HDD) or the like.

The display unit 15 is a display unit configured to perform various types of display for an image-capturing person, and is, for example, a display panel or a viewfinder by a display device such as a liquid crystal display (LCD) or an organic electro-luminescence (EL) display disposed in a housing of the image-capturing apparatus 1.

The display unit 15 executes various types of display onto a display screen on the basis of an instruction from the camera control unit 18.

For example, the display unit 15 displays a reproduction image of the image data read from the recording medium in the recording control unit 14.

Furthermore, there is a case where image data of a captured image whose resolution has been converted for display by the camera signal processing unit 13 is supplied to the display unit 15, and the display unit 15 performs display on the basis of the image data of the captured image in response to an instruction from the camera control unit 18. Due to this, a so-called through-the-lens image (subject monitoring image), which is a captured image during composition checking, is displayed.

Furthermore, on the basis of an instruction from the camera control unit 18, the display unit 15 executes various operation menus, icons, messages, and the like, that is, display as a graphical user interface (GUI) onto the screen.

The output unit 16 performs data communication and network communication with external equipment in a wired or wireless manner.

For example, captured image data (for example, movie file MF) is transmitted and output to an external display apparatus, recording apparatus, reproduction apparatus, and the like.

Furthermore, as a network communication unit, the output unit 16 may perform communication via various networks such as the Internet, a home network, and a local area network (LAN), and transmit and receive various data to and from a server, a terminal, or the like on the network.

The operation unit 17 collectively indicates input devices for the user to perform various types of operation input. Specifically, the operation unit 17 indicates various operators (keys, dials, touchscreens, touch pads, and the like) provided in the housing of the image-capturing apparatus 1.

A user's operation is detected by the operation unit 17, and a signal corresponding to the input operation is transmitted to the camera control unit 18.

The camera control unit 18 includes a microcomputer (arithmetic processing apparatus) including a central processing unit (CPU).

The memory unit 19 stores information and the like used for processing by the camera control unit 18. The memory unit 19 that is illustrated comprehensively presents, for example, a read only memory (ROM), a random access memory (RAM), a flash memory, and the like.

The memory unit 19 may be a memory region built in a microcomputer chip as the camera control unit 18 or may be configured by a separate memory chip.

By executing a program stored in the ROM, the flash memory, or the like of the memory unit 19, the camera control unit 18 controls the entire image-capturing apparatus 1.

For example, the camera control unit 18 controls the operation of each necessary unit regarding control of the shutter speed of the image-capturing element unit 12, an instruction of various types of signal processing in the camera signal processing unit 13, an image capturing operation and a recording operation according to the user's operation, a reproduction operation of the recorded movie file MF and the like, operations of the lens system 11 such as zooming, focusing, and diaphragm adjustment in a lens barrel, the user interface operation, and the like.

The RAM in the memory unit 19 is used for temporary storage of data, programs, and the like as a work area at the time of various data processing of the CPU of the camera control unit 18.

The ROM and the flash memory (nonvolatile memory) in the memory unit 19 are used for storing an operating system (OS) for the CPU to control each unit, content files such as the movie file MF, application programs for various operations, firmware, and the like.

The driver unit 22 is provided with, for example, a motor driver for a zoom lens drive motor, a motor driver for a focus lens drive motor, a motor driver for a motor of a diaphragm mechanism, and the like.

These motor drivers apply a drive current to a corresponding driver in response to an instruction from the camera control unit 18, and cause the drivers to execute movement of the focus lens and the zoom lens, opening and closing of a diaphragm blade of the diaphragm mechanism, and the like.

The sensor unit 23 comprehensively indicates various sensors mounted on the image-capturing apparatus.

The sensor unit 23 is mounted with, for example, an inertial measurement unit (IMU) in which an angular velocity (gyro) sensor of three axes of pitch, yaw, and roll, for example, can detect an angular velocity, and an acceleration sensor can detect an acceleration.

Note that the sensor unit 23 only needs to include a sensor capable of detecting camera shake at the time of image capturing, and does not need to include both the gyro sensor and the acceleration sensor.

Furthermore, as the sensor unit 23, a position information sensor, an illuminance sensor, or the like may be mounted.

For example, the movie file MF as a movie captured and generated by the image-capturing apparatus 1 described above can be transferred to the image processing apparatuses TDx and TDy such as the mobile terminal 2 and subjected to image processing.

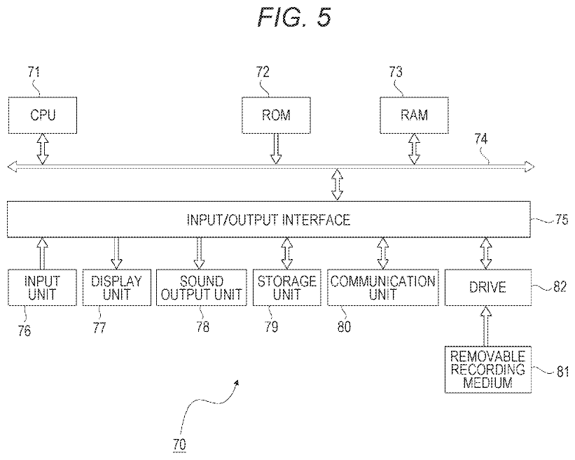

The mobile terminal 2 and the personal computer 3 serving as the image processing apparatuses TDx and TDy can be achieved as an information processing apparatus including the configuration illustrated in FIG. 5, for example. Note that the server 4 can be similarly achieved by the information processing apparatus having the configuration of FIG. 5.

In FIG. 5, a CPU 71 of an information processing apparatus 70 executes various types of processing according to a program stored in a ROM 72 or a program loaded from a storage unit 79 into a RAM 73. The RAM 73 also appropriately stores data and the like necessary for the CPU 71 to execute various types of processing.

The CPU 71, the ROM 72, and the RAM 73 are connected to one another via a bus 74. An input/output interface 75 is also connected to this bus 74.

An input unit 76 including an operator and an operation device is connected to the input/output interface 75.

For example, as the input unit 76, various operators and operation devices such as a keyboard, a mouse, a key, a dial, a touchscreen, a touch pad, and a remote controller are assumed.

A user's operation is detected by the input unit 76, and a signal corresponding to the input operation is interpreted by the CPU 71.

Furthermore, a display unit 77 including an LCD or an organic EL panel and a sound output unit 78 including a speaker are connected to the input/output interface 75 integrally or separately.

The display unit 77 is a display unit configured to perform various types of display, and includes, for example, a display device provided in the housing of the information processing apparatus 70, a separate display device connected to the information processing apparatus 70, or the like.

The display unit 77 executes display of an image for various types of image processing, a movie of the processing target, and the like onto the display screen on the basis of an instruction from the CPU 71. Furthermore, on the basis of an instruction from the CPU 71, the display unit 77 displays various operation menus, icons, messages, and the like, that is, display as a graphical user interface (GUI).

In some cases, the storage unit 79 including a hard disk, a solid-state memory, or the like, and a communication unit 80 including a modem or the like are connected to the input/output interface 75.

The communication unit 80 performs communication processing via a transmission path such as the Internet, wired/wireless communication with various types of equipment, communication by bus communication, and the like.

A drive 82 is also connected to the input/output interface 75 as necessary, and a removable recording medium 81 such as a magnetic disk, an optical disk, a magneto-optical disk, or a semiconductor memory is appropriately mounted.

A data file such as the movie file MF, various computer programs, and the like can be read from the removable recording medium 81 by the drive 82. The data file having been read is stored in the storage unit 79, and images and audio included in the data file are output by the display unit 77 and the sound output unit 78. Furthermore, the computer program and the like read from the removable recording medium 81 are installed in the storage unit 79 as necessary.

In this information processing apparatus 70, software for image processing as the image processing apparatus of the present disclosure, for example, can be installed via network communication by the communication unit 80 or the removable recording medium 81. Alternatively, the software may be stored in advance in the ROM 72, the storage unit 79, or the like.

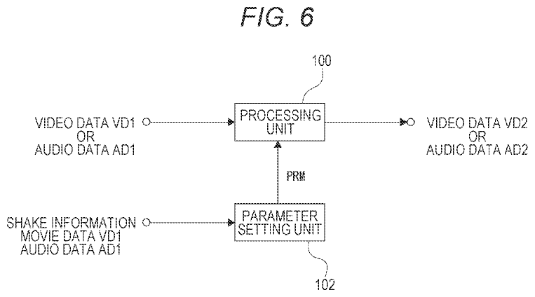

For example, the functional configuration as in FIG. 6 is constructed in the CPU 71 of the information processing apparatus 70 by such software (application program).

FIG. 6 illustrates a function provided as the information processing apparatus 70 functioning as the image processing apparatus TDx, for example. That is, the information processing apparatus 70 (CPU 71) includes functions as a processing unit 100 and a parameter setting unit 102.

The processing unit 100 indicates a function of performing shake change processing, image processing, audio processing, or the like.

For example, the processing unit 100 performs shake change processing on the movie data VD1 transmitted from the image source VS such as the image-capturing apparatus 1, and performs processing to provide the movie data VD2 to be output.

Furthermore, for example, the processing unit 100 performs image processing such as luminance processing and color processing on the movie data VD1, and performs processing to provide the movie data VD2 to be output.

Furthermore, for example, the processing unit 100 performs audio processing such as volume change or frequency characteristic change on the audio data AD1 transmitted from the image source VS and performs processing to provide the audio data AD2 to be output.

The processing of this processing unit 100 is controlled by the parameter PRM from the parameter setting unit 102. The parameter setting unit 102 sets the parameter PRM according to shake information on the movie data VD1, the movie data VD1, or the audio data AD1.

As a result, the processing of the processing unit 100 is executed according to the shake information on the movie data VD1, the movie data VD1, or the audio data AD1.

That is, the parameter setting unit 102 performs parameter setting processing of setting the parameter PRM of the processing of the other element according to one element of the first element that is one element of a plurality of elements related to shake of the movie data VD1 to be input and the second element (element of the movie data VD1, element of the audio data AD1, or other shake element of the movie data VD1) that is an element related to the movie data VD1 to be input and other than the first element.

Then, the processing unit 100 performs processing related to the other element using the parameter PRM set by the parameter setting unit 102.

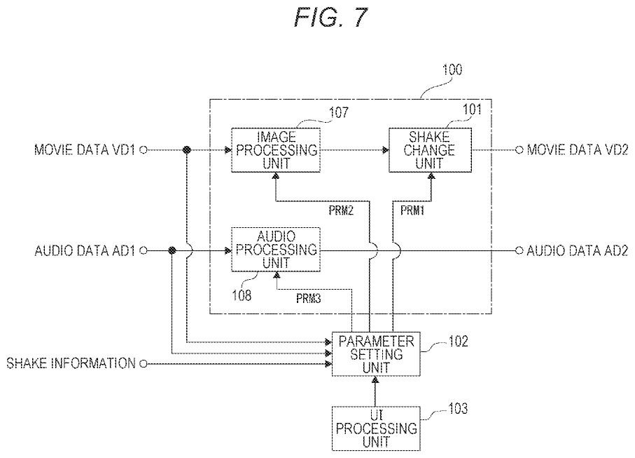

A more specific functional configuration example is illustrated in FIG. 7.

As the processing unit 100, a shake change unit 101, an image processing unit 107, and an audio processing unit 108 are illustrated.

The movie data VD1 is subjected to, for example, image processing in the image processing unit 107 or shake change in the shake change unit 101, and is output as the movie data VD2.

The processing order of the image processing unit 107 and the shake change unit 101 may be the order opposite to the illustrated order.

The image processing unit 107 has a function of performing, according to a parameter PRM2, image processing of changing elements of various images. As the image processing, for example, luminance processing, color processing, image effect processing, and the like of the movie data VD1 are assumed. More specifically, for example, it is conceivable to change the brightness and hue of the image, and change the level of tone change, sharpness, blur, mosaic, resolution, and the like of the image.

The shake change unit 101 has a function of performing, according to a parameter PRM1, shake change processing on a shake element of the movie data VD1.

As an example of the element of shake, a shake direction-wise element is considered, and examples of the shake direction-wise element include a shake component in the pitch direction, a shake component in the yaw direction, a shake component in the roll direction, and a shake component in the dolly direction (depth direction). In the present embodiment, the above direction-wise element will be described as an example of the shake element, but as the shake element, for example, high-frequency shake, low-frequency shake, and the like divided by the shake frequency can be considered.

As described above, the shake change includes shake removal, shake partial removal, and shake addition. Note that these processing may be shake change for production or shake change for cancellation of shake.

The audio processing unit 108 has a function of performing, according to a parameter PRM3, audio processing of changing various audio elements. As the audio processing, for example, volume processing, audio quality processing, and acoustic effect processing of the audio data AD1 are assumed. More specifically, for example, an increase or decrease in volume, a variation in frequency characteristics, a pitch variation, a phase difference change of stereo audio, a change in panning state, and the like can be considered.

As described in FIG. 5, the parameter setting unit 102 sets the parameter PRM according to shake information about the movie data VD1, the movie data VD1, or the audio data AD1, and this parameter PRM is any one or a plurality of the shake change parameter PRM1, the image processing parameter PRM2, and the audio processing parameter PRM3.

In the present disclosure, these parameters are referred to as “parameter PRM1”, “parameter PRM2”, and “parameter PRM3” in a case of distinguishing them.

The parameter setting unit 102 and the processing unit 100 perform processing of the other element according to one element related to the movie data VD1, which is processing as listed below.

The parameter PRM1 is set according to a shake element (one or a plurality of elements) of the movie data VD1, and the shake change unit 101 performs shake change processing of changing another element (one or a plurality of elements) of shake.

The parameter PRM2 is set according to a shake element (one or a plurality of elements) of the movie data VD1, and the image processing unit 107 performs image processing of changing an element (one or a plurality of elements) of the image of the movie data VD1.

The parameter PRM3 is set according to a shake element (one or a plurality of elements) of the movie data VD1, and the audio processing unit 108 performs audio processing of changing an audio element (one or a plurality of elements) of the audio data AD1.

The parameter PRM1 is set according to an element (one or a plurality of elements) of the movie data VD1, and the shake change unit 101 performs shake change processing of changing an element (one or a plurality of elements) of shake.

The parameter PRM1 is set according to an element (one or a plurality of elements) of the audio data AD1, and the shake change unit 101 performs shake change processing of changing an element (one or a plurality of elements) of shake.

The parameter PRM1 is set according to an element (one or a plurality of elements) of the movie data VD1 and the element (one or a plurality of elements) of the audio data AD1, and the shake change unit 101 performs shake change processing of changing an element (one or a plurality of elements) of shake.

The parameter PRM1 is set according to an element (one or a plurality of elements) of the movie data VD1 and an element (one or a plurality of elements) of shake, and the shake change unit 101 performs shake change processing of changing another element (one or a plurality of elements) of shake.

The parameter PRM1 is set according to an element (one or a plurality of elements) of the audio data AD1 and an element (one or a plurality of elements) of shake, and the shake change unit 101 performs shake change processing of changing another element (one or a plurality of elements) of shake.

The parameter PRM1 is set according to an element (one or a plurality of elements) of the movie data VD1, an element (one or a plurality of elements) of the audio data AD1, and an element (one or a plurality of elements) of shake, and the shake change unit 101 performs shake change processing of changing another element (one or a plurality of elements) of shake.

As the above processing, it is possible to change an image, audio, or other shake component according to a shake component, or change a shake component according to an image or audio.

Note that although the shake change unit 101, the image processing unit 107, and the audio processing unit 108 are illustrated as the processing unit 100 in FIG. 7, at least one of the shake change unit 101, the image processing unit 107, and the audio processing unit 108 is only required to be provided as the configuration of the processing unit 100 in FIG. 6.

FIG. 7 also illustrates a function as a user interface processing unit 103.

Note that “user interface” is also referred to as “UI”, and the user interface processing unit 103 is hereinafter also referred to as “UI processing unit 103”.

The UI processing unit 103 is a function of processing of presenting an operator regarding conversion or reflection among a shake element, an image element, and an audio element to the user and acquiring operation information by the operator.

For example, the UI processing unit 103 performs processing of causing the display unit 77 to display, as a UI image, an image indicating information regarding an operator and an image. Furthermore, the UI processing unit 103 detects a user's operation with the input unit 76. For example, a touch operation or the like on a UI image is detected.

The operation information detected by the UI processing unit 103 is sent to the parameter setting unit 102, and the parameter setting unit 102 performs parameter setting according to the operation information.

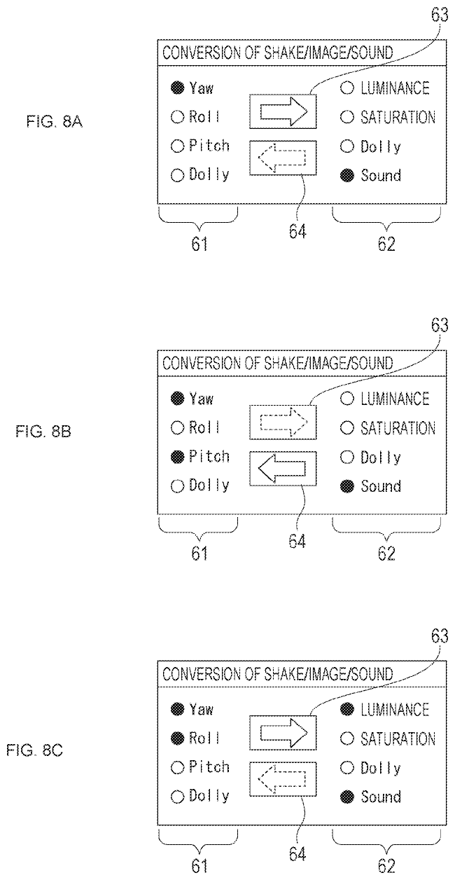

FIG. 8A illustrates an example of an operator presented to the user by the processing of the UI processing unit 103. It is an example of an operator that presents conversion of an element among a shake element, an image, and audio to the user.

For example, “yaw”, “roll”, “pitch”, and “dolly” are displayed as the elements of shake as an element selection unit 61 on the left side, and one or a plurality of elements can be selected with a radio button.

Furthermore, as an element selection unit 62 on the right side, “luminance” and “saturation” as elements of image, “dolly” as an element of shake, and “sound” as an element of sound are displayed, and one or a plurality of elements can be selected by a radio button.

The direction to be reflected can be designated by arrow buttons 63 and 64.

For example, FIG. 8A illustrates a state in which the user selects “yaw” in the element selection unit 61, selects “sound” in the element selection unit 62, and selects the arrow button 63.

In this case, the parameter setting unit 102 sets the parameter PRM3 according to the yaw component of the shake information, and the audio processing unit 108 performs the audio processing according to the yaw component.

FIG. 8B illustrates a state in which the user selects “yaw” and “pitch” in the element selection unit 61, selects “sound” in the element selection unit 62, and selects the arrow button 64.

In this case, the parameter setting unit 102 sets the parameter PRM1 according to the element of the audio data AD1, and the shake change unit 101 performs the shake change processing of the yaw component and the pitch component according to the element of audio.

FIG. 8C illustrates a state in which the user selects “yaw” and “roll” in the element selection unit 61, selects “luminance” and “sound” in the element selection unit 62, and selects the arrow button 63.

In this case, the parameter setting unit 102 sets the parameters PRM2 and PRM3 according to the yaw component and the roll component of the shake information, the image processing unit 107 performs image processing according to the yaw component and the roll component, and the audio processing unit 108 performs audio processing according to the yaw component and the roll component.

For example, the element of the reflection source and the element of the reflection destination are designated by the user operation in this manner, and thus, a production effect of image or audio according to the intention of the user, and the like are achieved. Of course, the example of FIG. 8 is an example. In the operator, an audio element can be selected as “sound”, but an element such as “volume” or “audio quality” may be selected in more detail.

Note that an example in which element selection based on a user operation is performed is described, but this is an example. It is also conceivable that the element of the reflection source and the element of the reflection destination are automatically selected not on the basis of the user operation. For example, the parameter setting unit 102 may determine an appropriate reflection source element by image analysis of the movie data VD1, audio analysis of the audio data AD1, and shake information analysis, and set the parameter setting by setting an appropriate reflection destination element.

In the functional configurations illustrated in FIGS. 6 and 7 described above, it is possible to mutually convert a vibration element and another element.

For example, an image effect or an acoustic effect is added by converting vibration into brightness, color, or audio.

Alternatively, inversely, an image effect of shake is added by converting an element of audio or image into vibration (shake components such as yaw, pitch, roll, and dolly).

Alternatively, the axis of vibration is converted, such as turning a roll shake into a dolly shake.

As described above, the production effect can be enhanced by converting a certain element into another element and adding the element to the image or audio.

For example, by putting, over an audio or music, a frequency and an amplitude of shake (vertical shake or the like) applied to an image, it is possible to produce a feeling of shaking according to the image rather than ordinary speech or music.

In the case of a vertical shake (pitch) component, the impact can be emphasized by increasing the amplitude (volume) of the audio at the time of large shake.

In the case of a horizontal shake (yaw) component, it is possible to further express the state of shaking right and left by giving a phase difference between the right and left sounds of the stereo according to the right and left shaking.

In the case of a rotation (roll) component, by modulating all of the amplitude, pitch, and phase difference of the sound according to the shake amount, it is possible to give an effect as if being confused.

Conversely, in a case where the sound is an explosive sound or a vibration sound, it is possible to produce shake of the image corresponding to the sound by putting the frequency and amplitude over the image.

In a case where a large sound is emitted, the image is further shaken by adding a vertical shake to the image according to the volume, so that it is possible to emphasize the feeling of shaking.

In a case where the frequency of a sound is low such as an explosive sound, a shake feeling that expresses an explosion or the like is obtained by adding a small number of times of shake, and in a case where the frequency is high, a feeling that expresses a fine shake is obtained by continuously adding a fine shake.

Furthermore, by reflecting, for example, a roll component of the unsteady image on the image as a dolly or zoom motion, it is possible to add a more unsteady feeling.

When the shake is large, for example, when the shake is in the upward direction during vertical shake, the screen is made brighter, and when the shake is in the downward direction, the screen is made darker, so that the shake production by the change in brightness can be performed.

The feeling of further confusion can be emphasized by changing the hue in the red hue direction in the clockwise direction and in the blue hue direction in the counterclockwise direction according to the shake in the rotation (roll) direction.

Here, an example in which a certain element is reflected to another element will be described. Here, an example of reflecting a shake element in a sound element will be described.

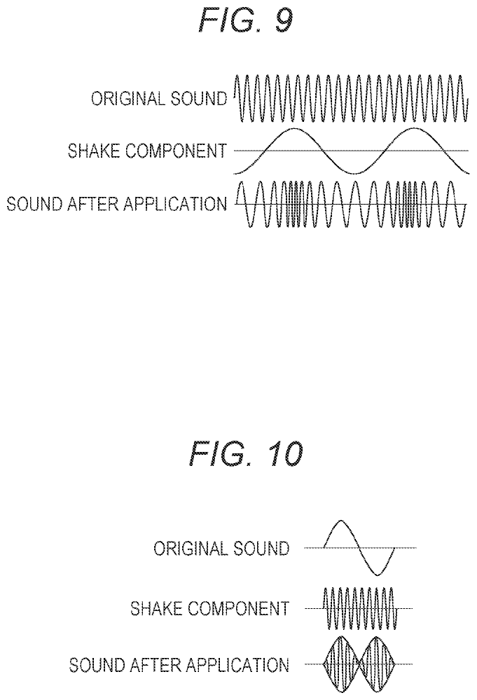

FIG. 9 illustrates an example in which a shake component is applied to a sound height (pitch or frequency).

This is processing of frequency-modulating the waveform of the original sound with a shake component. For example, it becomes audio processing represented by

A·sin(θ+θyure).

Note that “A” is an audio data value, and “θyure” is a shake component.

FIG. 10 illustrates an example in which a shake component is applied to a sound height (pitch or frequency).

This is processing of amplitude-modulating the waveform of the original sound with a shake component. For example, it becomes audio processing represented by

A·Ayure·sin(θ).

Note that “Ayure” is an amplitude component of shake.

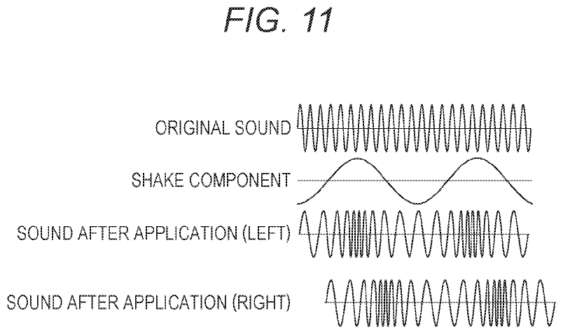

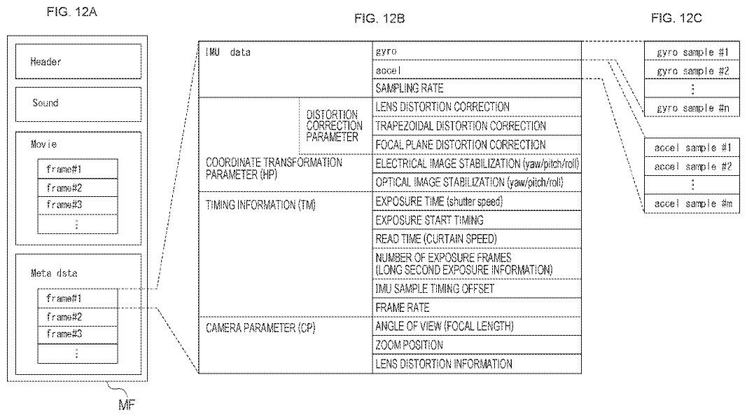

FIG. 11 illustrates an example in which a shake component is applied to a phase difference in a case where the audio data AD1 is a signal of a plurality of channels such as a stereo signal. For example,

Left channel: A·sin(θ+θyure)

Right channel: A·sin(θ−θyure).

The above is an example in which a shake element is reflected in a sound element, but there are various specific examples in which a certain element is reflected in another element.

<3. Movie File and Metadata>

Hereinafter, an example in which the above-described processing of reflecting a certain element into another element is performed for the movie file MF captured by the image-capturing apparatus 1 serving as the image source VS and input to the image processing apparatus TDx will be described.

First, the content of the movie file MF and the content of the metadata to be transmitted from the image source VS such as the image-capturing apparatus 1 to the image processing apparatus TDx will be described.

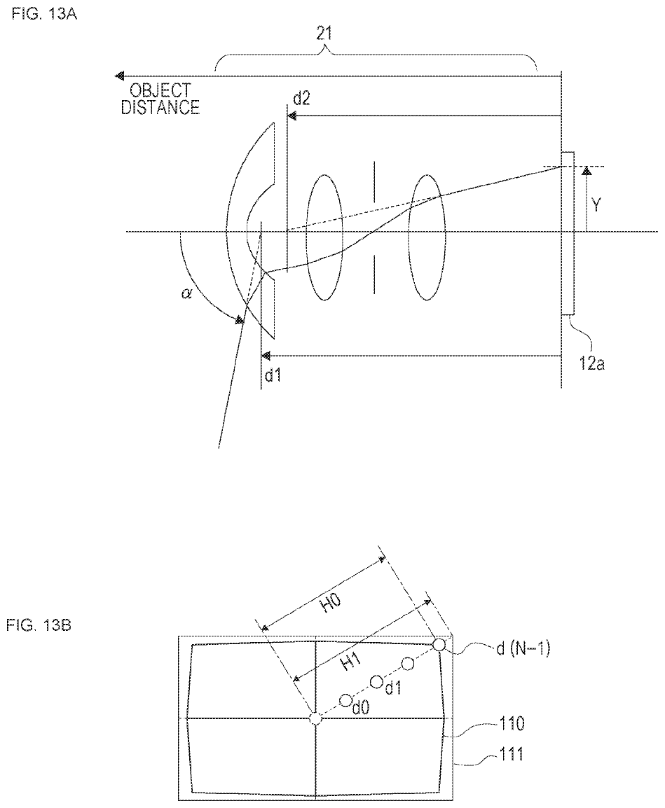

FIG. 12A illustrates data included in the movie file MF. As illustrated, the movie file MF includes various data as “header”, “sound”, “movie”, and “metadata”.

In “header”, information indicating the presence or absence of metadata and the like are described together with information such as a file name and a file size.

“Sound” is audio data AD1 recorded together with the movie. For example, two-channel stereo audio data is stored.

“Movie” is movie data, and includes image data as each frame (#1, #2, #3 . . . ) constituting the movie.

As “metadata”, additional information associated with the respective frames (#1, #2, #3 . . . ) constituting the movie is described.

A content example of the metadata is illustrated in FIG. 12B. For example, IMU data, the coordinate transformation parameter HP, timing information TM, and a camera parameter CP are described for one frame. Note that these are part of the metadata content, and only information related to image processing described later is illustrated here.

As the IMU data, a gyro (angular velocity data), an accelerator (acceleration data), and a sampling rate are described.

The IMU mounted on the image-capturing apparatus 1 as the sensor unit 23 outputs angular velocity data and acceleration data at a predetermined sampling rate. In general, this sampling rate is higher than the frame rate of the captured image, and thus many IMU data samples are obtained in one frame period.

Therefore, as the angular velocity data, n samples are associated with one frame, such as a gyro sample #1, a gyro sample #2, . . . , and a gyro sample #n illustrated in FIG. 12C.

Furthermore, also as the acceleration data, m samples are associated with one frame, such as an accelerator sample #1, an accelerator sample #2, . . . , and an accelerator sample #m.

There is a case where n=m and there is a case where n≠m.

Note that, although the example in which the metadata is associated with each frame is described here, there is a case where, for example, IMU data is not completely synchronized with a frame. In such case, for example, time information related to time information of each frame is made to be held as an IMU sample timing offset in the timing information TM.

The coordinate transformation parameter HP is a generic term for parameters used for correction involving coordinate transformation of each pixel in an image. It also includes non-linear coordinate transformation such as lens distortion.

Then, the coordinate transformation parameter HP is a term that can include at least a lens distortion correction parameter, a trapezoidal distortion correction parameter, a focal plane distortion correction parameter, an electrical image stabilization parameter, and an optical image stabilization parameter.

The lens distortion correction parameter is information for directly or indirectly grasping how distortion such as barrel aberration and pincushion aberration is corrected and returning the image to an image before lens distortion correction. The metadata regarding the lens distortion correction parameter as one of the metadata will be briefly described.

FIG. 13A illustrates an image height Y, an angle α, an incident pupil position d1, and an exit pupil position d2 in a schematic diagram of the lens system 11 and the image sensor 12a.

The lens distortion correction parameter is used to know the incident angle for each pixel of the image sensor 12a in the image processing. Therefore, it is only required to know the relationship between the image height Y and the angle α.

FIG. 13B illustrates an image 110 before lens distortion correction and an image 111 after lens distortion correction. A maximum image height H0 is a maximum image height before distortion correction, and is a distance from the center of the optical axis to the farthest point. A maximum image height H1 is a maximum image height after distortion correction.

What is necessary as metadata so that the relationship between the image height Y and the angle a is known is the maximum image height H0 before distortion correction and data d0, d1, . . . d(N−1) of the incident angle with respect to the respective N image heights. “N” is assumed to be about 10 as an example.

Returning to FIG. 12B, the trapezoidal distortion correction parameter is a correction amount at the time of correction of trapezoidal distortion caused by shifting the clipping region from the center by the electrical image stabilization, and also has a value corresponding to the correction amount of the electrical image stabilization.

The focal plane distortion correction parameter is a value indicating a correction amount for each line with respect to focal plane distortion.

The electrical image stabilization and the optical image stabilization are parameters indicating a correction amount in each axial direction of yaw, pitch, and roll.

Note that the parameters of the lens distortion correction, the trapezoidal distortion correction, the focal plane distortion correction, and the electrical image stabilization are collectively referred to as coordinate transformation parameters, and this is because these correction processing are correction processing for an image formed on each pixel of the image sensor 12a of the image-capturing element unit 12, and they are parameters of correction processing involving coordinate transformation of each pixel. This is because, although the optical image stabilization is also one of the coordinate transformation parameters, correction of shake of an interframe component in the optical image stabilization becomes processing involving coordinate transformation of each pixel.

That is, by performing reverse correction using these parameters, image data subjected to the lens distortion correction, the trapezoidal distortion correction, the focal plane distortion correction, the electrical image stabilization, and the optical image stabilization can be returned to a state before each correction processing, that is, the state when the image is formed on the image sensor 12a of the image-capturing element unit 12.

Furthermore, parameters of the lens distortion correction, the trapezoidal distortion correction, and the focal plane distortion correction are collectively referred to as optical distortion correction parameters because they are distortion correction processing for a case where the optical image itself from the subject is an image captured in an optically distorted state, and each parameter is intended for optical distortion correction.

That is, when inverse correction is performed using these parameters, image data subjected to the lens distortion correction, the trapezoidal distortion correction, and the focal plane distortion correction can be returned to the state before the optical distortion correction.

The timing information TM in metadata includes information of an exposure time (shutter speed), an exposure start timing, a read time (curtain speed), the number of exposure frames (long second exposure information), an IMU sample offset, and a frame rate.

In the image processing of the present embodiment, these are mainly used to associate the line of each frame with IMU data.

However, even in a case where the image sensor 12a is a CCD or a global shutter type CMOS, in a case where the exposure center of gravity is shifted by using an electronic shutter or a mechanical shutter, it is possible to perform correction in accordance with the exposure center of gravity by using the exposure start timing and the curtain speed.

As the camera parameter CP in the metadata, an angle of view (focal length), a zoom position, and lens distortion information are described.

<4. Image Processing of Embodiment>

A processing example of the information processing apparatus 70 serving as the image processing apparatus TDx as the embodiment will be described.

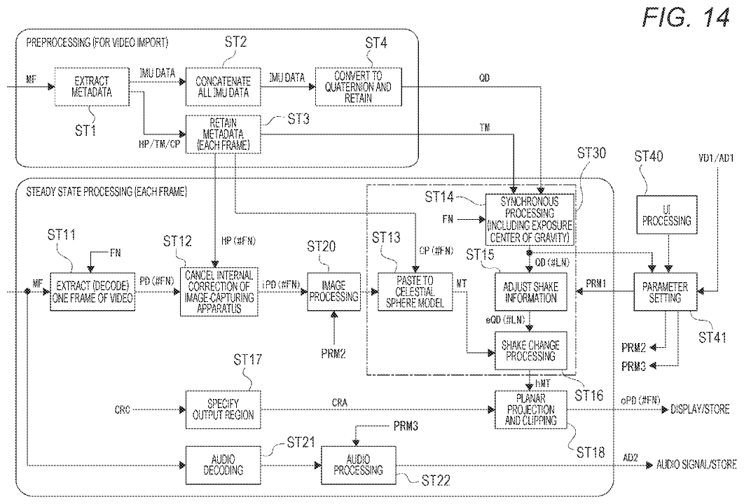

FIG. 14 illustrates a procedure of various types of processing executed in the information processing apparatus 70 as the image processing apparatus TDx, and illustrates the relationship among information used in each processing.

Note that, depending on the function of the shake change unit 101 in FIG. 7, processing of steps ST13, ST14, ST15, and ST16 enclosed as step ST30 in FIG. 14 is performed.

Depending on the function of the image processing unit 107, image processing in step ST20 is performed.

Depending on the function of the audio processing unit 108, audio processing in step ST22 is performed.

Depending on the function of the parameter setting unit 102, parameter setting processing in step ST41 is performed.

Depending on the function of the UI processing unit 103, the UI processing in step ST40 is performed.

As the processing of FIG. 14, first, steps ST1, ST2, ST3, and ST4 as preprocessing will be described.

The preprocessing is processing performed when the movie file MF is imported.

The term “import” as used here refers to setting, as an image processing target, the movie file MF or the like that can be accessed by being taken in to the storage unit 79 or the like, for example, by the information processing apparatus 70, and refers to performing preprocessing to develop the file so as to enable image processing. For example, it does not refer to transferring from the image-capturing apparatus 1 to the mobile terminal 2 or the like.

The CPU 71 imports the movie file MF designated by a user operation or the like so as to be an image processing target, and performs processing related to the metadata added to the movie file MF as preprocessing. The CPU 71 performs processing of extracting and storing metadata corresponding to each frame of a movie, for example.

Specifically, in this preprocessing, metadata extraction (step ST1), all IMU data consolidation (step ST2), metadata retention (step ST3), and conversion into quaternion (posture information of the image-capturing apparatus 1) and retention (step ST4) are performed.

As metadata extraction in step ST1, the CPU 71 reads the target movie file MF and extracts the metadata included in the movie file MF as described with reference to FIG. 12.

Note that part or all of steps ST1, ST2, ST3, and ST4 may be performed on the image source VS side such as the image-capturing apparatus 1. In that case, in the preprocessing, the content after those processing described below are acquired as metadata.

The CPU 71 performs consolidation processing in step ST2 regarding IMU data (angular velocity data (gyro sample) and acceleration data (accelerator sample)) among the extracted metadata.

This is processing of arranging and consolidating all pieces of IMU data associated with all frames in time series order and constructing IMU data corresponding to the entire sequence of the movie.

Then, integration processing is performed on the consolidated IMU data to calculate, store, and retain a quaternion QD representing the posture of the image-capturing apparatus 1 at each time point on the sequence of the movie. Calculating the quaternion QD is an example.

Note that the quaternion QD can be calculated only with angular velocity data.

The CPU 71 performs processing of retaining, in step ST3, metadata other than the IMU data, that is, the coordinate transformation parameter HP, the timing information TM, and the camera parameter CP among the extracted metadata. That is, the coordinate transformation parameter HP, the timing information TM, and the camera parameter CP are stored in a state corresponding to each frame.

By performing the above preprocessing, the CPU 71 is prepared to perform various types of image processing including shake change on movie data received as the movie file MF.

The steady state processing in FIG. 14 indicates image processing performed, as a target, on the movie data of the movie file MF subjected to the preprocessing as described above.

The CPU 71 performs processing of one frame extraction of the movie (step ST11), internal correction cancellation of image-capturing apparatus (step ST12), image processing (step ST20), pasting to the celestial sphere model (step ST13), synchronization processing (step ST14), shake information adjustment (step ST15), shake change (step ST16), output region designation (step ST17), plane projection and clipping (step ST18), audio decoding (step ST21), and audio processing (step ST22).

The CPU 71 performs each processing of steps ST11 to ST20 described above for each frame at the time of image reproduction of the movie file MF.

In step ST11, the CPU 71 decodes one frame of the movie (the movie data VD1 of the movie file MF) along a frame number FN. Then, movie data PD (#FN) of one frame is output. Note that “(#FN)” indicates a frame number and indicates information corresponding to the frame.

Note that in a case where the movie has not been subjected to encoding processing such as compression, the decoding processing in step ST11 is unnecessary.

The movie data PD of one frame is image data constituting the movie data VD1.

In step ST21, the CPU 71 decodes the audio data AD1 synchronized with the frame. Note that, here, it is sufficient that the audio processing of step ST22 is enabled, and there is a case where decoding processing is unnecessary depending on the content of the audio processing, the format of the movie file MF, and the like.

In step ST22, the CPU 71 performs audio processing according to the parameter PRM3, and outputs the processed audio data AD2.

For example, processing such an increase or decrease in volume, a variation in frequency characteristics, a pitch variation, a phase difference change of stereo audio, and a change in panning state are assumed.

Note that the audio processing mentioned here is processing performed according to the parameter PRM3, and in a case where an execution trigger of processing with the parameter PRM3 is not generated, the audio data AD1 input without performing the audio processing in particular is output as the audio data AD2 as it is.

In step ST12, the CPU 71 performs processing of canceling the internal correction performed by the image-capturing apparatus 1 for the movie data PD (#FN) of one frame.

For this purpose, with reference to the coordinate transformation parameter HP (#FN) stored corresponding to the frame number (#FN) at the time of preprocessing, the CPU 71 performs reverse correction to the correction performed by the image-capturing apparatus 1. Thus, movie data iPD (#FN) in a state where the lens distortion correction, the trapezoidal distortion correction, the focal plane distortion correction, the electrical image stabilization, and the optical image stabilization in the image-capturing apparatus 1 are canceled is obtained. That is, it is movie data where shake removal and the like performed by the image-capturing apparatus 1 have been canceled and the influence of the shake such as camera shake at the time of image capturing appears as it is. This is because the correction processing at the time of image capturing is canceled to bring into the state before correction, and more accurate shake removal and shake addition using image-capturing time shake information (for example, quaternion QD) are performed.

However, the processing of internal correction cancellation of image-capturing apparatus as step ST12 needs not be performed. For example, the processing of step ST12 may be skipped, and the movie data PD (#FN) may be output as it is.

In step ST20, the CPU 71 performs image processing on the movie data iPD (#FN) according to the parameter PRM2.

For example, it is assumed processing to change the brightness and hue of the image, and change the level of tone change, sharpness, blur, mosaic, resolution, and the like of the image.

Note that the image processing mentioned here is processing performed according to the parameter PRM2, and in a case where an execution trigger of processing with the parameter PRM2 is not generated, the movie data iPD (#FN) is output as it is without performing the image processing in particular.

Note that the image processing in step ST20 is not limited to be performed on the movie data iPD (#FN) at this stage, and may be performed on output movie data oPD described later. Therefore, for example, step ST20 may be performed as processing subsequent to step ST18 described later.

In step ST13, the CPU 71 pastes the movie data iPD (#FN) of one frame to the celestial sphere model. At this time, the camera parameter CP (#FN) stored corresponding to the frame number (#FN), that is, the angle of view, the zoom position, and the lens distortion information are referred to.

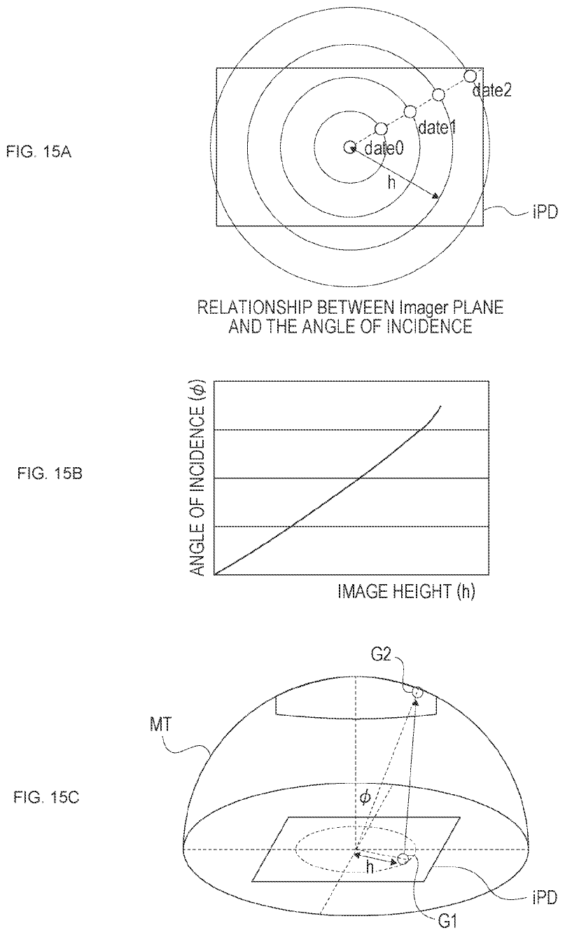

FIG. 15 illustrates an outline of pasting to the celestial sphere model.

FIG. 15A illustrates the movie data iPD. The image height h is a distance from the image center. Each circle in the figure indicates the position where the image height h becomes equal.

From the angle of view, the zoom position, and the lens distortion information of a frame of this movie data iPD, “relationship between an image sensor surface and an incident angle φ” in the frame is calculated and set as “data 0” . . . “data N−1” at each position of the image sensor surface. Then, the relationship is expressed as a one-dimensional graph of a relationship between the image height h and the incident angle φ as in FIG. 15B from “data 0” . . . and “data N−1”. The incident angle φ is an angle of a light beam (an angle viewed from the optical axis).

The one-dimensional graph is rotated once around the center of the captured image, and the relationship between each pixel and the incident angle is obtained.

Accordingly, mapping of each pixel of the movie data iPD onto the celestial sphere model MT is performed such as a pixel G1 in FIG. 15C to a pixel G2 on a celestial sphere coordinates.

As described above, an image (data) of the celestial sphere model MT in which a captured image is pasted to an ideal celestial sphere surface in a state where lens distortion is removed is obtained. In this celestial sphere model MT, parameters and distortion unique to the image-capturing apparatus 1 that originally captured the movie data iPD are removed, and the range visible by an ideal pinhole camera is what is pasted to the celestial sphere surface.

Therefore, by rotating the image of the celestial sphere model MT in a predetermined direction in this state, shake change processing as shake removal or shake production can be achieved.

Here, posture information (quaternion QD) of the image-capturing apparatus 1 is used for the shake change processing. For this purpose, the CPU 71 performs synchronization processing in step ST14.

In the synchronization processing, processing of specifying and acquiring a quaternion QD (#LN) suitable for each line is performed corresponding to the frame number FN. Note that “(#LN)” indicates the line number in a frame and represents information corresponding to the line.

Note that the reason for use of the quaternion QD (#LN) for each line is that in a case where the image sensor 12a is a CMOS type and performs rolling shutter image capturing, the amount of shake varies for each line.

For example, in a case where the image sensor 12a is a CCD type and performs global shutter image capturing, it is sufficient to use the quaternion QD (#FN) in units of frames.

Note that even in the case of a global shutter of a CCD or a CMOS as the image sensor 12a, the center of gravity is shifted when an electronic shutter (the same applies to a mechanical shutter) is used, and therefore, it is preferable to use a quaternion at the timing of the center (shifted according to the shutter speed of the electronic shutter) of the exposure period of the frame.

Here, blur appearing in an image is considered.

The blur occurs in an image due to relative motion between an image-capturing apparatus and a subject in a same frame. That is, the image blur is caused by shake within an exposure time. The longer the exposure time becomes, the stronger the influence of blur becomes.

In the electrical image stabilization, in a case where a method of controlling an image range clipped for each frame is used, “shake” occurring between frames can be reduced/eliminated, but relative shake within an exposure time cannot be reduced by such electrical image stabilization.

Furthermore, when the clipping region is changed by image stabilization, posture information of each frame is used. However, if the posture information deviates from the center of the exposure period such as the timing of start or end of an exposure period, the direction of shake within the exposure time based on the posture is biased, and the blur is easily noticeable. Moreover, in a rolling shutter of CMOS, the exposure period varies for every line.

Therefore, in the synchronization processing in step ST14, for each frame of the movie data, the quaternion QD is acquired with reference to the timing of the exposure center of gravity for each line.

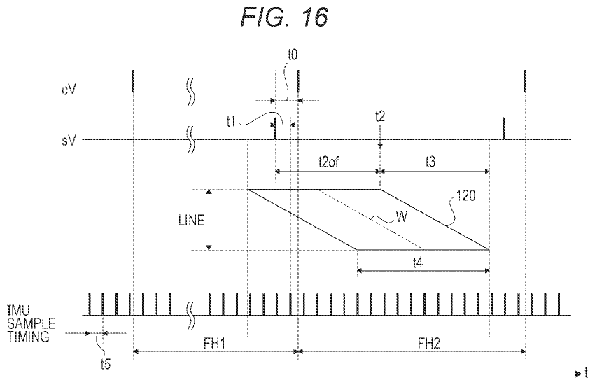

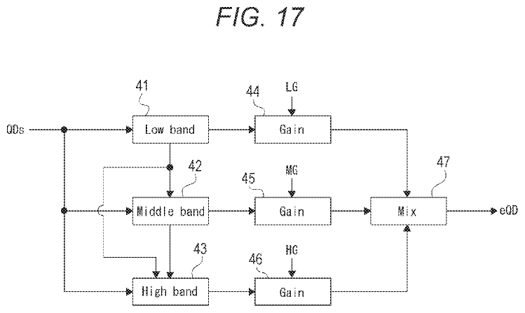

FIG. 16 illustrates a synchronization signal cV in the vertical period of the image-capturing apparatus 1, a synchronization signal sV of the image sensor 12a generated from this synchronization signal cV, and a sample timing of the IMU data, and also illustrates an exposure timing range 120.

The exposure timing range schematically indicates, in a parallelogram, an exposure period of each line of one frame when an exposure time t4 is set by a rolling shutter method. Furthermore, a temporal offset t0, an IMU sample timing offset t1, a read start timing t2, a read time (curtain speed) t3, and an exposure time t4 of the synchronization signal cV and the synchronization signal sV are illustrated. Note that the read start timing t2 is a timing after a predetermined time t2of has elapsed from the synchronization signal sV.

Each IMU data obtained at each IMU sample timing is associated with a frame. For example, the IMU data in a period FH1 is metadata associated with the current frame indicating the exposure period in a parallelogram, and the IMU data in the period FH1 is metadata associated with the next frame. However, by consolidating all IMU data in step ST2 of FIG. 14, association between each frame and IMU data is released, and the IMU data can be managed in time series.

In this case, the IMU data corresponding to the exposure center of gravity (timing of broken line W) of each line of the current frame is specified. This can be calculated if the temporal relationship between the IMU data and an effective pixel region of the image sensor 12a is known.

Therefore, IMU data corresponding to the exposure center of gravity (timing of broken line W) of each line is specified using information that can be acquired as the timing information TM corresponding to the frame (#FN).

That is, it is information of the exposure time, the exposure start timing, the read time, the number of exposure frames, the IMU sample offset, and the frame rate.

Then, the quaternion QD calculated from the IMU data of the exposure center of gravity is specified and set as a quaternion QD (#LN) that is posture information for each line.

This quaternion QD (#LN) is provided to shake information adjustment processing in step ST15.

In shake information adjustment, the CPU 71 adjusts the quaternion QD according to the shake change parameter PRM having been input.

The shake change parameter PRM is a parameter input according to a user operation or a parameter generated by automatic control.

The user can input the shake change parameter PRM so as to add a discretionary shake degree to the image. Furthermore, the CPU 71 can generate the shake change parameter PRM by automatic control according to image analysis, an image type, a selection operation of a model of shake by the user, or the like, and use the shake change parameter PRM.

Here, FIG. 14 illustrates UI processing in step ST40 and parameter setting processing in step ST41.

By the UI processing, the user can perform an operation input for instructing a shake change. That is, an operation of instructing shake as shake production, an operation of instructing a degree of shake removal, or the like is performed.

In addition, in the case of the present embodiment, the UI processing (ST40) causes the operator illustrated in FIG. 8A or the like to be displayed, and enables the user to perform a selection operation for reflecting a certain element in another element.

On the basis of the UI processing in step ST40, the CPU 71 performs various parameter settings in step ST41. For example, a shake change parameter PRM1 according to a user operation is set and used for shake information adjustment processing in step ST15. The parameter PRM1 includes parameters as shake removal and shake production, but is also a parameter in a case where a certain element is reflected in a certain shake element as described above.

Furthermore, in step ST41, there is a case where the CPU 71 sets the parameter PRM2 of the image processing to be used in the image processing in step ST20.

Furthermore, in step ST41, there is a case where the CPU 71 sets the parameter PRM3 of the audio processing to be used in the audio processing in step ST22.

These parameters PRM1, PRM2, and PRM3 are set on the basis of information of a certain element. Therefore, in the parameter setting processing in step ST40, the quaternion QD (#LN) is referred to and analyzed as original shake information. In the parameter setting processing, the movie data VD1 and the audio data AD1, which are the origin of setting, are referred to and analyzed.

In the shake information adjustment processing of step ST15, the CPU 71 generates the adjusted quaternion eQD for shake addition to the image or increasing or decreasing the amount of shake on the basis of the quaternion QD that is image-capturing time shake information and the shake change parameter PRM1 set in step ST41.

A specific generation example of the adjusted quaternion eQD will be described with reference to FIGS. 17, 18, and 19.

FIG. 17 illustrates an example of generating the adjusted quaternion eQD in accordance with an instruction of a frequency band-wise gain by the parameter PRM1.

The frequency band is a band of a shake frequency. For the sake of description, it is assumed that the band is divided into three bands of a low band, a middle band, and a high band. Of course, this is merely an example, and the number of bands only needs to be two or more.

A low gain LG, a middle gain MG, and a high gain HG are provided as the shake change parameter PRM1.

An adjustment processing system in FIG. 17 includes a low-pass filter 41, a middle-pass filter 42, a high-pass filter 43, gain arithmetic units 44, 45, and 46, and a synthesis unit 47.

“Quaternion QDs for shaking” is input to this adjustment processing system. This is the conjugation of the quaternion QDs as image-capturing time shake information.

Each value q for the current frame and the preceding and following predetermined frames as the quaternion QDs for shaking is input to the low-pass filter 41 to obtain a low component q_{low}.

q_{low}=mean(q,n) [Expression 1]

The gain arithmetic unit 44 gives a low gain LG to this low component q_{low}.

Mean (q, n) in the expression represents a mean value of n values before and after q.

Note that this expression of mean (q, n) is merely an example of a low-pass filter, and it goes without saying that other calculation methods may be used. Each expression described below is also an example.

The value q of the quaternion QDs for shaking is input to the middle-pass filter 42 to obtain a middle component q_{mid}.

q_{mid}=q*_{low}×mean(q,m) [Expression 2]
where n>m

Note that q*_{low} is the conjugate of q_{low}.

Furthermore, “×” is a quaternion product.

The gain arithmetic unit 45 gives a middle gain MG to this middle component q_{mid}.

Furthermore, the value q of the quaternion QDs for shaking is input to the high-pass filter 43 to obtain a high component g_{high} .

q_{high}=q*_{mid}×q*_{low}×q [Expression 3]

Note that q*_{mid} is the conjugate of q_{mid}.

The gain arithmetic unit 46 gives a high gain HG to this high component q_{high}.

These gain arithmetic units 44, 45, and 46 assume input as “qᵢₙ”.

$${q}_{in} = [ \begin{matrix}\begin{matrix}\begin{matrix}cos \frac{θ}{2} & {a}_{x} sin \frac{θ}{2}\end{matrix} & {a}_{y} sin \frac{θ}{2}\end{matrix} & {a}_{z} sin \frac{θ}{2}\end{matrix} ] \qquad [ Expression 4 ]$$

At this case, a next “qₒᵤₜ” is output with θ′=θ*gain.

(where gain is the low gain LG, the middle gain MG, and the high gain HG.)

$${q}_{out} = [ \begin{matrix}\begin{matrix}\begin{matrix}cos \frac{{θ}^{′}}{2} & {a}_{x} sin \frac{{θ}^{′}}{2}\end{matrix} & {a}_{y} sin \frac{{θ}^{′}}{2}\end{matrix} & {a}_{z} sin \frac{{θ}^{′}}{2}\end{matrix} ] \qquad [ Expression 5 ]$$

By such gain arithmetic units 44, 45, and 46, the low component q′_{low}, the middle component q′_{mid}, and the high component q′_{high} to which the low gain LG, the middle gain MG, and the high gain HG are given, respectively, are obtained. These are synthesized by the synthesis unit 47 to obtain a value q_{mixed}.

q_{mixed}=q′_{low}×q′_{mid}×q′_{high} [Expression 6]

Note that “×” is a quaternion product.

The value q_{mixed} thus obtained becomes the value of the adjusted quaternion eQD.

Although the above is an example of band division, a method of generating the adjusted quaternion eQD in which a gain according to the parameter PRM1 is given without band division is also conceivable.

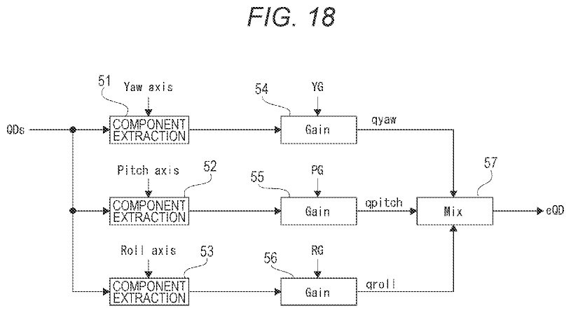

Next, FIG. 18 illustrates an example in which the adjusted quaternion eQD is generated according to an instruction of a gain for each direction by the shake change parameter PRM1.

The direction is a direction of shaking, that is, directions of yaw, pitch, and roll.

A yaw gain YG, a pitch gain PG, and a roll gain RG are given as the shake change parameter PRM.

An adjustment processing system in FIG. 18 includes a yaw component extraction unit 51, a pitch component extraction unit 52, a roll component extraction unit 53, gain arithmetic units 54, 55, and 56, and a synthesis unit 57.

The yaw component extraction unit 51, the pitch component extraction unit 52, and the roll component extraction unit 53 are provided with information on a yaw axis, a pitch axis, and a roll axis, respectively.

Respective values q for the current frame and the preceding and following predetermined frames as the quaternion QDs for shaking are input to the yaw component extraction unit 51, the pitch component extraction unit 52, and the roll component extraction unit 53, respectively, to obtain a yaw component q_{yaw}, a pitch component q_{pitch}, and a roll component qᵣₒₗₗ.

Each component extraction processing assumes a next “qᵢₙ” as input.

$${q}_{in} = [ \begin{matrix}\begin{matrix}\begin{matrix}cos \frac{θ}{2} & {a}_{x} sin \frac{θ}{2}\end{matrix} & {a}_{y} sin \frac{θ}{2}\end{matrix} & {a}_{z} sin \frac{θ}{2}\end{matrix} ] \qquad [ Equation 7 ]$$

$$u = [ \begin{matrix}\begin{matrix}{u}_{x} & {u}_{y}\end{matrix} & {u}_{z} ]\end{matrix}$$

u is a unit vector representing the direction of an axis such as the yaw axis, the pitch axis, or the roll axis.

At this case, a next “qₒᵤₜ” is output with θ′=θ*(a·u).

$${q}_{out} = [ \begin{matrix}\begin{matrix}\begin{matrix}cos \frac{{θ}^{′}}{2} & {u}_{x} sin \frac{{θ}^{′}}{2}\end{matrix} & {u}_{y} sin \frac{{θ}^{′}}{2}\end{matrix} & {u}_{z} sin \frac{{θ}^{′}}{2}\end{matrix} ] \qquad [ Expression 8 ]$$

For the yaw component q_{yaw}, the pitch component q_{pitch}, and the roll component qᵣₒₗₗ obtained by such component extraction, the gain arithmetic units 54, 55, and 56 give the yaw gain YG, the pitch gain PG, and the roll gain RG, respectively.

Then, the yaw component q′_{Yaw}, the pitch component q′_{pitch}, and the roll component q′ᵣₒₗₗ subjected to the gain arithmetic operation are synthesized by the synthesis unit 47 to obtain the value q_{mixed}.

q_{mixed}=q′_{yaw}×q′_{pitch}×q′ᵣₒₗₗ [Expression 9]

Note that “×” in this case is also a quaternion product.

The value q_{mixed} thus obtained becomes the value of the adjusted quaternion eQD.

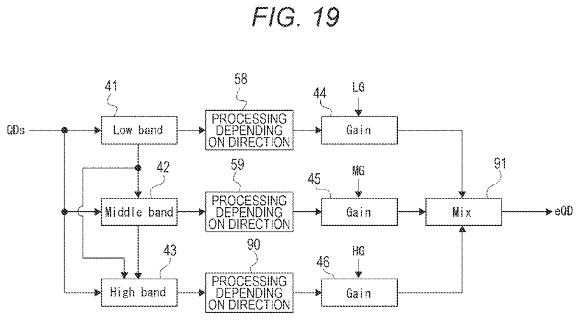

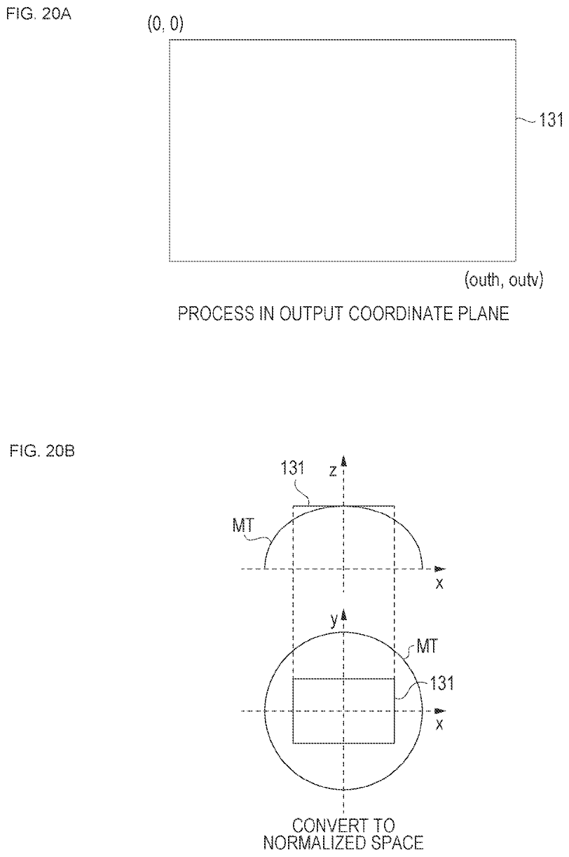

FIG. 19 illustrates an example in which the frequency band and the direction are combined.

An adjustment processing system includes the low-pass filter 41, the middle-pass filter 42, the high-pass filter 43, direction-wise processing units 58, 59, and 90, the gain arithmetic units 44, 45, and 46, and a synthesis unit 91.

Depending on the parameter PRM1 for shake change, the low gain LG, the middle gain MG, the high gain HG, and the yaw gain YG, the pitch gain PG, and the roll gain RG that are not illustrated are given.

In this adjustment processing system, respective values q for the current frame and the preceding and following predetermined frames as the quaternion QDs for shaking supplied to the low-pass filter 41, the middle-pass filter 42, and the high-pass filter 43, respectively, to obtain respective band components. The respective band components are input to the direction-wise processing units 58, 59, and 90.

Each of the direction-wise processing units 58, 59, and 90 are assumed to include the yaw component extraction unit 51, the pitch component extraction unit 52, the roll component extraction unit 53, the gain arithmetic units 54, 55, and 56, and the synthesis unit 57 in FIG. 18.

That is, the direction-wise processing unit 58 divides the low component of the quaternion QDs for shaking into components in the yaw direction, the roll direction, and the pitch direction, performs gain arithmetic operation using the yaw gain YG, the pitch gain PG, and the roll gain RG, and then synthesizes them.

The direction-wise processing unit 59 divides the middle component of the quaternion QDs for shaking into components in the yaw direction, the roll direction, and the pitch direction, similarly performs gain arithmetic operation, and then synthesizes them.

The direction-wise processing unit 90 divides the high component of the quaternion QDs for shaking into components in the yaw direction, the roll direction, and the pitch direction, similarly performs gain arithmetic operation, and then synthesizes them.

Note that the gains used in the direction-wise processing units 58, 59, and 90 are assumed to have different gain values. That is, the direction-wise processing unit 58 uses the low yaw gain YG, the low pitch gain PG, and the low roll gain RG, the direction-wise processing unit 59 uses the middle yaw gain YG, the middle pitch gain PG, and the middle roll gain RG, and the direction-wise processing unit 90 uses the high yaw gain YG, the high pitch gain PG, and the high roll gain RG. That is, it is conceivable that the direction-wise processing units 58, 59, and 90 use nine gains.

Outputs of these direction-wise processing units 58, 59, and 90 are supplied to the gain arithmetic units 44, 45, and 46, respectively, and are given the low gain LG, the middle gain MG, and the high gain HG, respectively. Then, they are synthesized by the synthesis unit 91 and output as a value of the adjusted quaternion eQD.

In the example of FIG. 19 described above, after division to the frequency band first, direction direction-wise processing is applied for each band component, but this may be reversed. That is, after division for each direction first, frequency band-wise processing may be applied for each direction component.

In that case, it is conceivable to use nine gains in the frequency band-wise processing. For example, in the frequency band-wise processing in the yaw direction, a low gain LG for the yaw direction, a middle gain MG for the yaw direction, and a high gain HG for the yaw direction are used. In the frequency band-wise processing in the pitch direction, a low gain LG for the pitch direction, a middle gain MG for the pitch direction, and a high gain HG for the pitch direction are used. In the frequency band-wise processing in the roll direction, a low gain LG for the roll direction, a middle gain MG for the roll direction, and a high gain HG for the roll direction are used.

The yaw gain YG, the pitch gain PG, the roll gain RG, the low gain LG, the middle gain MG, and the high gain HG have been described above as the parameters PRM1, and these are parameters for performing change processing of shake elements (direction-wise elements and frequency band-wise elements). Therefore, a shake of only a certain element can be changed by setting of the parameter PRM1.

In step ST15 of FIG. 14, for example, the adjusted quaternion eQD is generated by the above processing example.

Then, the adjusted quaternion eQD having been generated is provided to the shake change processing in step ST16.

The shake change processing in step ST16 can be considered as adding a shake by applying the adjusted quaternion eQD obtained by the processing in FIGS. 17, 18, and 19 to an image in a state where the shake is stopped.

In the shake change processing in step ST16, using the adjusted quaternion eQD (#LN) for each line, the CPU 71 adds the shake by rotating an image of the celestial sphere model MT to which the image of the frame is pasted in step ST13. An image of a celestial sphere model hMT with the shake having been changed is sent to the processing of step ST18.

Then, in step ST18, the CPU 71 projects, onto a plane, and clips the image of the celestial sphere model hMT with the shake having been changed, so that an image (output movie data oPD) having been subjected to shake change is obtained.

In this case, shake change is achieved by rotation of the celestial sphere model MT, and by using the celestial sphere model MT, a trapezoidal shape does not appear even if any portion is clipped, and as a result, trapezoidal distortion is eliminated. Furthermore, as described above, since in the celestial sphere model MT, the range visible by an ideal pinhole camera is what is pasted to the celestial sphere surface, there is no lens distortion. Since the rotation of the celestial sphere model MT is performed according to the adjusted quaternion eQD (#LN) based on the quaternion QD (#LN) for each line, focal plane distortion correction is also eliminated.

Furthermore, since the quaternion QD (#LN) corresponds to the exposure center of gravity of each line, blur is unnoticeable in the image.

Association between an image after subjected to plane projection in step ST18 and the celestial sphere model MT is as follows.

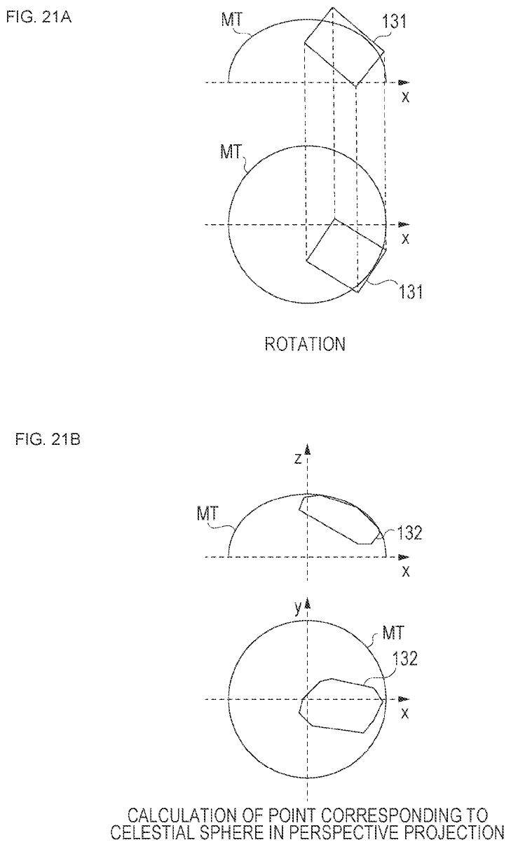

FIG. 20A illustrates an example of a rectangular coordinate plane 131 subjected to plane projection. The coordinate of the image subjected to plane projection is assumed to be (x, y).

As illustrated in FIG. 20B, the coordinate plane 131 is arranged (normalized) in a three-dimensional space so as to be in contact with the center immediately above the celestial sphere model MT. That is, the center of the coordinate plane 131 is arranged at a position coinciding with the center of the celestial sphere model MT and in contact with the celestial sphere model MT.

In this case, the coordinate is normalized on the basis of zoom magnification and the size of a clipping region. For example, as in FIG. 20A, in a case where a horizontal coordinate of the coordinate plane 131 is 0 to outh and a vertical coordinate is 0 to outv, outh and outv are an image size, Then, for example, the coordinate is normalized by the following expression.

$${x}_{norm} = \frac{1}{zoom} \cdot \frac{( x - outh / 2 )}{r} \qquad [ Expression 10 ]$$

$${y}_{norm} = \frac{1}{zoom} \cdot \frac{( y - outv / 2 )}{r}$$

$${z}_{norm} = 1$$

where r=min (outh, outv)/2

In the above (Expression 10), min(A, B) is a function that returns the smaller value of A and B. Furthermore, “zoom” is a parameter for controlling scaling.

Furthermore, xnorm, ynorm, and znorm are normalized x, y, and z coordinates.

The coordinate of the coordinate plane 131 is normalized to the coordinate on a spherical surface of a hemisphere having a radius 1.0 by each expression of (Expression 10) above.

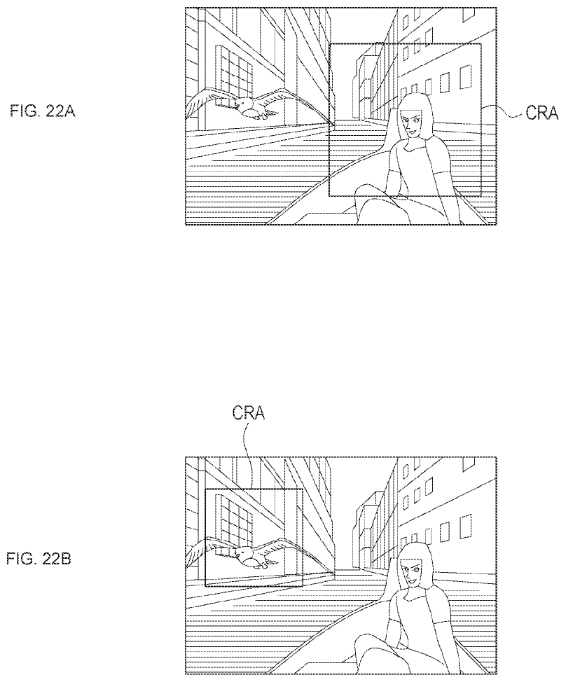

For rotation in order to obtain an orientation of a clipping region, the coordinate plane 131 is rotated by a rotation matrix operation as illustrated in FIG. 21A. That is, using a rotation matrix of the following (Expression 11), rotation is performed at a pan angle, a tilt angle, and a roll angle. Here, the pan angle is a rotation angle at which the coordinate is rotated about the z axis. The tilt angle is a rotation angle at which the coordinate is rotated about the x axis, and the roll angle is a rotation angle at which the coordinate is rotated about the y axis.

$$( \begin{matrix}{x}_{rot} \\ {y}_{rot} \\ {z}_{rot}\end{matrix} ) = ( \begin{matrix}1 & 0 & 0 \\ 0 & cos {R}_{t} & - sin {R}_{t} \\ 0 & s i n {R}_{t} & cos {R}_{t}\end{matrix} ) ( \begin{matrix}cos {R}_{r} & 0 & - sin {R}_{r} \\ 0 & 1 & 0 \\ sin {R}_{r} & 0 & cos {R}_{r}\end{matrix} ) ( \begin{matrix}cos {R}_{p} & - sin {R}_{p} & 0 \\ sin {R}_{p} & cos {R}_{p} & 0 \\ 0 & 0 & 1\end{matrix} ) ( \begin{matrix}\begin{matrix}{x}_{norm} \\ {y}_{norm}\end{matrix} \\ {z}_{norm}\end{matrix} ) \qquad [ Expression 11 ]$$

In the above (Expression 11), “Rt” is the tilt angle, “Rr” is the roll angle, and “Rp” is the pan angle. Furthermore, (xrot, yrot, zrot) is the coordinate after rotation.

This coordinate (xrot, yrot, zrot) is used for celestial sphere corresponding point calculation in perspective projection.

As in FIG. 21B, the coordinate plane 131 is subjected to perspective projection onto a celestial sphere surface (region 132). That is, it is to obtain a point intersecting the spherical surface when a straight line is drawn from the coordinate toward the center of the celestial sphere. Each coordinate is calculated as follows.

xₛₚₕ=xᵣₒₜ/\sqrt{xᵣₒₜ²+yᵣₒₜ²+zᵣₒₜ²}

yₛₚₕ=yᵣₒₜ/\sqrt{xᵣₒₜ²+yᵣₒₜ²+zᵣₒₜ²}

zₛₚₕ=zᵣₒₜ/\sqrt{xᵣₒₜ²+yᵣₒₜ²+zᵣₒₜ²} [Expression 12]

In (Expression 12), xsph, ysph, and zsph are coordinates at which the coordinate on the coordinate plane 131 is projected to the coordinate on the surface of the celestial sphere model MT.

Image data in which plane projection has been performed in this relationship is obtained.

For example, a clipping region for an image projected onto a plane by the above-described technique is set in step ST17 in FIG. 14.

In step ST17, clipping region information CRA in the current frame is set on the basis of tracking processing by image analysis (subject recognition) or clipping region instruction information CRC according to the user operation.

For example, FIGS. 22A and 22B illustrate, in a frame state, the clipping region information CRA set for an image of a certain frame.

Such clipping region instruction information CRC is set for each frame.

Note that the clipping region information CRA also reflects an instruction for an aspect ratio of an image by the user or automatic control.

The clipping region information CRA is reflected in the processing of step ST18. That is, as described above, the region corresponding to the clipping region information CRA is subjected to plane projection onto the celestial sphere model MT, and the output movie data oPD is obtained.

The output movie data oPD thus obtained is movie data subjected to the shake change processing in step ST16, for example. This shake change may be addition or increase or decrease of shake in response to an operation performed by the user simply to add a specific shake for production, or may be a shake change in which a certain element is reflected in a certain shake element.

Furthermore, there is a case where the output movie data oPD is data subjected to the image processing in step ST20. Such output movie data oPD corresponds to the movie data VD2 illustrated in FIG. 2 and the like.

Furthermore, the audio data AD2 is output corresponding to the output movie data oPD (movie data VD2). There is a case where the audio data AD2 is data subjected to the audio processing in step ST22.

The movie data VD2 and the audio data AD2 are data in which an image, an audio, or another shake element is changed according to the shake element, or data in which a shake component is changed according to the image or the audio.

In a case where such the movie data VD2 and the audio data AD2 are reproduced by the image processing apparatus TDx or transferred to the image processing apparatus TDy as the movie file MF and reproduced, an image or audio to which an effect converted between elements is added is reproduced.

<6. Summary and Modifications>

In the above embodiment, the following effects can be obtained.

An embodiment incudes:

a parameter setting unit 102 (ST41) configured to set a parameter of processing of another element according to one element of a first element that is one element among a plurality of elements related to a shake of input movie data PD (movie file MF) and a second element that is an element related to the input movie data PD and other than the first element; and a processing unit configured to perform processing related to the another element by using a parameter set by the parameter setting unit 102. The processing units is the image processing unit 107 (ST20), the shake change unit 101 (ST16), the audio processing unit 108 (ST22), and the like.

Therefore, other shake elements, audio, brightness of an image, color of an image, or the like can be changed according to one element of shake, or conversely, one element of shake can be changed according to other shake elements, audio, brightness of an image, or color of an image. Therefore, it is possible to widen image production and image effects.

In the embodiment, an example in which the parameter setting unit 102 sets the parameter PRM that changes the second element according to the first element is described. Other shake components, audio, and luminance and color of an image are changed according to a shake component that is a first element, for example.

This makes it possible to perform image processing as changing an audio or image quality according to a shake component or adding a shake of another axis.

In the embodiment, an example in which the parameter setting unit 102 sets the parameter PRM that changes the first element according to the second element is described. For example, a shake component that is the first element is changed according to a shake component other than the first element, audio, or luminance or color of an image.

This makes it possible to perform image processing as adding a shake of a certain axis according to a certain shake component, audio, or image.

The example has been given in which the processing unit 100 of the embodiment includes the shake change unit 101 that performs processing of changing the shake state of the movie using the parameter PRM1 set by the parameter setting unit 102.

This makes it possible to perform image processing in which a shake component is changed according to a certain shake component, audio, or image.

An example in which the processing unit 100 of the embodiment includes the audio processing unit 108 that performs the audio signal processing using the parameter PRM3 set by the parameter setting unit 102 is described.

As a result, the volume and audio quality are changed according to a certain shake component, or an acoustic effect is available. For example, it is possible to cause an increase or decrease in volume according to shake, a variation in frequency characteristics according to shake, a pitch variation according to shake, a phase difference change of stereo audio according to shake, a change in panning state according to shake, and the like. This makes it possible to perform audio expression according to shake in a movie.

The example in which the processing unit 100 of the embodiment includes the image processing unit 107 that performs the image signal processing using the parameter PRM2 set by the parameter setting unit 102 is described.

Therefore, the state of luminance, color, image effect, and the like of the image is changed according to a certain shake component. For example, it is conceivable to change the brightness and hue of the image, and change the level of tone change, sharpness, blur, mosaic, resolution, and the like. This makes it possible to perform a new expression of the image itself of a movie according to the shake as a movie.

In the embodiment, an example of including the UI processing unit 103 for presenting an operator for selecting the first element and the second element is described.

This allows the user to select a discretionary element and reflect the selected element into a change of another discretionary element. Therefore, the user can instruct desired expression by selecting an element in a case of reflecting a shake into another element or of reflecting a certain element into a shake.

The operator in FIG. 8 described in the embodiment includes a display for presenting directivity from one element to the other element for the first element and the second element.

As illustrated in FIG. 8, the arrow buttons 63 and 64 display the reflection direction between the selected elements. This makes it possible to provide a display that is intuitively easy for the user to understand, and the effect of the image or audio to be instructed becomes easy to understand.

Furthermore, the operator in FIG. 8 of the embodiment can designate one or both of the first element and the second element a plurality of times.

For example, as illustrated in FIG. 8B, a plurality of shake components as the first element can be selected. Furthermore, the example of FIG. 8C illustrates a state in which a plurality of first elements and a plurality of second elements are selected. By setting the number of selectable elements to be discretionary, more various image/audio expression becomes possible.

Note that a plurality of one of the first element and the second element may be designatable.

In the embodiment, the element of a shake of the input movie data includes at least any of a shake in a yaw direction, a shake in a pitch direction, a shake in a roll direction, and a shake in a dolly direction.

Since shake change is possible with a shake in each direction as one element, a shake production effect that is easy for the user to understand can be exhibited.

Note that, as described above, for example, a high shake component, a middle shake component, and a low shake component as frequency bands may be treated as elements.

Note that, in the embodiment, the element of reflection destination of the processing by the parameter is changed according to an element serving as a source of the parameter setting, and in this case, the original element is not changed, but the original element may be changed.

For example, as a case where the volume is changed according to the yaw component, an example is assumed in which processing of changing the volume is performed while maintaining the shake of the yaw component as it is, but in this case, processing of changing the volume by removing the shake of the yaw component may be performed. That is, it is the processing in which a certain original element is converted into another element, and the original element is removed or reduced. This makes it possible to convert a shake into a shake in another direction, an audio, or an image, or to convert an audio or an image state into a shake.

The program of the embodiment is a program for causing a CPU, a DSP, or a device including them to execute the processing described with reference to FIG. 14.

That is, the program of the embodiment is a program for causing an information processing apparatus to execute parameter setting processing (ST41) of setting a parameter of processing of another element according to one element of a first element that is one element among a plurality of elements related to a shake of input movie data PD (movie file MF) and a second element that is an element related to the input movie data PD and other than the first element, and processing (ST30, ST20, ST22) related to the another element by using a parameter set by the parameter setting processing.

Such program makes it possible to achieve the above-described image processing apparatus TDx in equipment such as the mobile terminal 2, the personal computer 3, or the image-capturing apparatus 1.

Such program for achieving the image processing apparatus TDx can be recorded in advance in an HDD as a recording medium built in equipment such as a computer apparatus, a ROM in a microcomputer having a CPU, or the like.

Alternatively, the program can be temporarily or permanently stored (recorded) in a removable recording medium such as a flexible disk, a compact disc read only memory (CD-ROM), a magneto optical (MO) disk, a digital versatile disc (DVD), a Blu-ray disc (registered trademark), a magnetic disk, a semiconductor memory, and a memory card. Such removable recording medium can be provided as so-called package software.

Furthermore, such program can be installed from a removable recording medium to a personal computer or the like, and can be downloaded from a download site via a network such as a local area network (LAN) or the Internet.

Furthermore, such program is suitable for widely providing the image processing apparatus TDx of the embodiment. For example, by downloading the program to a personal computer, a portable information processing apparatus, a mobile phone, a game console, video equipment, a personal digital assistant (PDA), and the like, the personal computer and the like can be caused to function as the image processing apparatus of the present disclosure.

Note that the effects described in the present description are merely examples and are not limited thereto, and other effects may be present.

Note that the present technology can also have the following configuration.

(1)

An image processing apparatus including:

a parameter setting unit configured to set a parameter of processing of another element according to one element of a first element that is one element among a plurality of elements related to a shake of input movie data and a second element that is an element related to the input movie data and other than the first element; and

a processing unit configured to perform processing related to the another element by using a parameter set by the parameter setting unit.

(2)

The image processing apparatus according to (1), in which

the parameter setting unit

sets a parameter for changing the second element according to the first element.

(3)

The image processing apparatus according to (1) or (2), in which

the parameter setting unit

sets a parameter for changing the first element according to the second element.

(4)

The image processing apparatus according to any one of (1) to (3), further including

a shake change unit configured to perform processing of changing a state of shake of a movie using a parameter set by the parameter setting unit as the processing unit.

(5)

The image processing apparatus according to any one of (1) to (4), further including

an audio processing unit configured to perform audio signal processing using a parameter set by the parameter setting unit as the processing unit.

(6)

The image processing apparatus according to any one of (1) to (5), further including

an image processing unit configured to perform image signal processing using a parameter set by the parameter setting unit as the processing unit.

(7)

The image processing apparatus according to any one of (1) to (6), further including

a user interface processing unit configured to present an operator for selecting the first element and the second element.

(8)

The image processing apparatus according to (7), in which

the operator presents directivity from the one element to the another element regarding the first element and the second element.

(9)

The image processing apparatus according to (7) or (8), in which

the operator can designate one or both of the first element and the second element a plurality of times.

(10)

The image processing apparatus according to any of (1) to (9), in which

a shake element of the input movie data includes at least any of a shake in a yaw direction, a shake in a pitch direction, a shake in a roll direction, and a shake in a dolly direction.

(11)

An image processing method, in which

an image processing apparatus performs

parameter setting processing of setting a parameter of processing of another element according to one element of a first element that is one element among a plurality of elements related to a shake of input movie data and a second element that is an element related to the input movie data and other than the first element, and

processing related to the another element by using a parameter set by the parameter setting processing.

(12)

A program that causes an information processing apparatus to execute

parameter setting processing of setting a parameter of processing of another element according to one element of a first element that is one element among a plurality of elements related to a shake of input movie data and a second element that is an element related to the input movie data and other than the first element, and

processing related to the another element by using a parameter set by the parameter setting processing.

### REFERENCE SIGNS LIST

1 Image-capturing apparatus

2 Mobile terminal

3 Personal computer

4 Server

5 Recording medium

61 Element selection unit

62 Element selection unit

63, 64 Arrow button

70 Information processing apparatus

71 CPU

100 Processing unit

101 Shake change unit

102 Parameter setting unit

103 UI processing unit

107 Image processing unit

108 Audio processing unit

1. An image processing apparatus comprising:
a parameter setting unit configured to set a parameter of processing of another element according to one element of a first element that is one element among a plurality of elements related to a shake of input movie data and a second element that is an element related to the input movie data and other than the first element; and
a processing unit configured to perform processing related to the another element by using a parameter set by the parameter setting unit.

2. The image processing apparatus according to claim 1, wherein
the parameter setting unit
sets a parameter for changing the second element according to the first element.

3. The image processing apparatus according to claim 1, wherein
the parameter setting unit
sets a parameter for changing the first element according to the second element.

4. The image processing apparatus according to claim 1, further comprising
a shake change unit configured to perform processing of changing a state of shake of a movie using a parameter set by the parameter setting unit as the processing unit.

5. The image processing apparatus according to claim 1, further comprising
an audio processing unit configured to perform audio signal processing using a parameter set by the parameter setting unit as the processing unit.

6. The image processing apparatus according to claim 1, further comprising
an image processing unit configured to perform image signal processing using a parameter set by the parameter setting unit as the processing unit.

7. The image processing apparatus according to claim 1, further comprising
a user interface processing unit configured to present an operator for selecting the first element and the second element.

8. The image processing apparatus according to claim 7, wherein
the operator presents directivity from the one element to the another element regarding the first element and the second element.

9. The image processing apparatus according to claim 7, wherein
the operator can designate one or both of the first element and the second element a plurality of times.

10. The image processing apparatus according to claim 1, wherein
a shake element of the input movie data includes at least any of a shake in a yaw direction, a shake in a pitch direction, a shake in a roll direction, and a shake in a dolly direction.

11. An image processing method, wherein
an image processing apparatus performs
parameter setting processing of setting a parameter of processing of another element according to one element of a first element that is one element among a plurality of elements related to a shake of input movie data and a second element that is an element related to the input movie data and other than the first element, and
processing related to the another element by using a parameter set by the parameter setting processing.

12. A program that causes an information processing apparatus to execute
parameter setting processing of setting a parameter of processing of another element according to one element of a first element that is one element among a plurality of elements related to a shake of input movie data and a second element that is an element related to the input movie data and other than the first element, and
processing related to the another element by using a parameter set by the parameter setting processing.
